(19) United States
(12) Patent Application Publication
(10) Pub. No.: US 2025/0355656 A1
(43) Pub. Date: Nov. 20, 2025

(54) MODEL CUSTOMIZATION AND DEPLOYMENT IN CONTAINERIZED ENVIRONMENTS

(71) Applicant: NVIDIA Corporation, Santa Clara, CA (US)

(72) Inventors: Nader Nouhad KHALIL, San Francisco, CA (US); Alecsander Quentin FONG, San Francisco, CA (US)

(73) Assignee: NVIDIA Corporation, Santa Clara, CA (US)

(21) Appl. No.: 19/199,032

(22) Filed: May 5, 2025

Related U.S. Application Data
(60) Provisional application No. 63/648,592, filed on May 16, 2024.

(51) Int. Cl. G06F 8/61; G06N 20/00

(52) U.S. Cl. CPC G06F 8/61; G06N 20/00

(57) ABSTRACT

Various examples, systems, and methods are disclosed relating to a model customization pipeline. A first computing system can receive at least one customization of at least one artificial intelligence (AI) model corresponding to a base instance. The first computing system can generate a customized instance of the at least one AI model by updating the base instance of the at least one AI model based on the at least one customization. The first computing system can generate a software component configured to perform at least one operation using the customized instance of the at least one AI model. The first computing system can package the software component and the customized instance of the at least one AI model into a first container instance. The first computing system can deploy the software component within a runtime environment.

### CROSS-REFERENCE TO RELATED APPLICATIONS

The present application claims the benefit of U.S. Provisional Patent Application No. 63/648,592, filed May 16, 2024, the disclosure of which is incorporated herein by reference in its entirety.

### BACKGROUND

Deploying customized artificial intelligence (AI) models in execution environments presents challenges. Some existing systems rely on rigid deployment workflows that require manual intervention to configure execution environments, allocating computing resources, and managing dependencies. These systems often limit the flexibility of AI model customization and deployment, leading to inefficiencies in resource utilization and model execution. Many existing solutions are inadequate for dynamically configuring software components that interact with AI models, instead relying on static container configurations or predefined infrastructure settings. These limitations affect the ability of systems to support AI model customization and deployment within cloud-based, edge, and/or hybrid computing environments.

### SUMMARY

Implementations of the present disclosure relate to systems and methods for generating, deploying, and executing customized AI models in containerized environments. For example, systems and methods in accordance with the present disclosure can generate a customized AI model instance based on received customizations, generate a software component configured to perform at least one operation using the customized AI model instance, and deploy the software component in a containerized execution environment. The containerized environment can include a runtime environment configured to execute the software component and facilitate interactions between the software component and the customized AI model instance. The system can dynamically allocate computing resources to support the execution of the containerized AI model and its corresponding software component. These implementations facilitate the generation, deployment, and execution of AI models within adaptable containerized environments, supporting cloud, edge, and/or distributed computing infrastructures.

Some implementations relate to a system. The system includes one or more processors configured to receive at least one customization of at least one artificial intelligence (AI) model corresponding to a base instance. The one or more processors are configured to generate a customized instance of the at least one AI model by updating the base instance of the at least one AI model based on the at least one customization. The one or more processors are configured to generate a software component configured to perform at least one operation using the customized instance of the at least one AI model. The one or more processors are configured to package the software component and the customized instance of the at least one AI model into a first container instance. The one or more processors are configured to deploy the software component within a runtime environment.

In some implementations, updating the base instance includes performing at least one of (i) fine-tuning, (ii) applying prompt tuning, or (iii) updating at least one model parameter of the base instance. In some implementations, the first container instance includes the runtime environment configured to execute the software component using the customized instance of the at least one AI model. In some implementations, the first container instance corresponds to an instantiation of a container image. In some implementations, the container image executes in an execution environment configured to provision at least one computing resource for executing the first container instance. In some implementations, packaging the software component and the customized instance includes generating the container image including the software component, the customized instance of the at least one AI model, and the runtime environment configured to execute the software component and instantiating the first container instance by loading the container image into the execution environment and allocating the at least one computing resource for execution.

In some implementations, the one or more processors are configured to launch a second container instance including a software development environment (SDE) and install the at least one AI model in the second container instance. In some implementations, the second container instance receives the at least one customization prior to generating the customized instance of the at least one AI model. In some implementations, the one or more processors are configured to provide, via the SDE, a user interface including a plurality of selectable elements. In some implementations, at least one first selectable element of the plurality of selectable elements corresponds to configuring and deploying a plurality of software components.

In some implementations, at least one second selectable element of the plurality of selectable elements corresponds to updating at least one model parameter. In some implementations, the one or more processors are configured to receive, via the SDE from the at least one first selectable element, a request to configure and deploy the software component. In some implementations, receiving the at least one customization includes receiving, from the at least one second selectable element, the at least one model parameter to update the base instance of the at least one AI model.

In some implementations, the user interface includes at least one content item corresponding to deployment and configuration information of the software component, the deployment and configuration information includes at least one of (i) compute information, (ii) container information, or (iii) file information. In some implementations, deploying the software component within the runtime environment is responsive to receiving a selection of at least one of the plurality of selectable elements. In some implementations, generating the software component includes generating software logic configured to receive at least one input and apply the at least one input to the customized instance of the at least one AI model to cause the customized instance to generate at least one output.

Some implementations relate to a system. The system including one or more processors configured to receive at least one customization of at least one artificial intelligence (AI) model corresponding to a base instance. The one or more processors are configured to generate a customized instance of the at least one AI model by updating the base instance of the at least one AI model based on the at least one customization. The one or more processors are configured to generate a software component configured to perform at least one operation using the customized instance of the at least one AI model. The one or more processors are configured to package the software component and the customized instance of the at least one AI model into a container image. The one or more processors are configured to provide, to a deployment system, the container image configured for execution of the software component in a container instance.

In some implementations, updating the base instance includes performing at least one of (i) fine-tuning, (ii) applying prompt tuning, or (iii) updating at least one model parameter of the base instance. In some implementations, the container instance includes the runtime environment configured to execute the software component using the customized instance of the at least one AI model. In some implementations, the container image executes in an execution environment configured to provision at least one computing resource for executing the first container instance.

In some implementations, the one or more processors are configured to provide, via a software development environment (SDE), a user interface including a plurality of selectable elements. In some implementations, at least one first selectable element of the plurality of selectable elements corresponds to configuring and deploying a plurality of software components. In some implementations, at least one second selectable element of the plurality of selectable elements corresponds to updating at least one model parameter. In some implementations, the one or more processors are configured to receive, via the SDE from the at least one first selectable element, a request to configure and deploy the software component. In some implementations, receiving the at least one customization includes receiving, from the at least one second selectable element, the at least one model parameter to update the base instance of the at least one AI model.

In some implementations, the user interface includes at least one content item corresponding to deployment and configuration information of the software component, the deployment and configuration information includes at least one of (i) compute information, (ii) container information, or (iii) file information. In some implementations, deploying the software component within the runtime environment is responsive to receiving a selection of at least one of the plurality of selectable elements. In some implementations, generating the software component includes generating software logic configured to receive at least one input and apply the at least one input to the customized instance of the at least one AI model to cause the customized instance to generate at least one output.

Some implementations relate to a method. The method includes receiving, using one or more processors, at least one customization of at least one artificial intelligence (AI) model corresponding to a base instance. The method includes generating, using the one or more processors, a customized instance of the at least one AI model by updating the base instance of the at least one AI model based on the at least one customization. The method includes generating, using the one or more processors, a software component configured to perform at least one operation using the customized instance of the at least one AI model. The method includes packaging, using the one or more processors, the software component and the customized instance of the at least one AI model into a first container instance. The method includes deploying, using the one or more processors, the software component within a runtime environment.

The processors, systems, and/or methods described herein can be implemented by or included in at least one of a system for customizing one or more AI models, a system for deploying one or more inference engines, a system for packaging the one or more inference engines and the one or more AI models into one or more containers, a system for executing one or more software components invoking the one or more AI models, a system for implementing one or more containerized execution environments, a system implementing one or more multi-model language models, a system implementing one or more large language models (LLMs), a system implementing one or more small language models (SLMs), a system implementing one or more vision language models (VLMs), a system for generating synthetic data, a system for generating synthetic data using AI, a control system for an autonomous or semi-autonomous machine, a perception system for an autonomous or semi-autonomous machine, a system for performing digital twin operations, a system for performing light transport simulation, a system for performing remote operations, a system implemented using an edge device, a system implemented using a robot, a system for performing conversational AI operations, a system incorporating one or more virtual machines (VMs), a system using or deploying one or more inference microservice, a system that incorporates one or more machine learning models deployed in a service or microservice along with an OS-level virtualization package, a system implemented at least partially in a data center, or a system implemented at least partially using cloud computing resources.

### BRIEF DESCRIPTION OF THE DRAWINGS

The present systems and methods for model customization and deployment in containerized environments are described in detail below with reference to the attached drawing figures, wherein:

FIG. 1 is a block diagram of an example of a system, in accordance with some implementations of the present disclosure;

FIG. 2 is a flow diagram of an example of a method for model customization and deployment in containerized environments in a model customization pipeline, in accordance with some implementations of the present disclosure;

FIGS. 3A-3D depict an example interface for model customization and deployment in containerized environments, in accordance with some implementations of the present disclosure;

FIGS. 4A-4B depict an example interface for model customization and deployment in containerized environments, in accordance with some implementations of the present disclosure;

FIG. 5 is a block diagram of a system configured to support turnkey model customization and deployment of inference engines, in accordance with some implementations of the present disclosure;

FIG. 6 is a flow diagram of an example of a method for turnkey model customization and deployment of inference engines, in accordance with some implementations of the present disclosure;

FIG. 7 depicts an example interface for model customization and deployment of inference engines, in accordance with some implementations of the present disclosure;

FIG. 8A is a block diagram of an example generative language model system suitable for use in implementing at least some implementations of the present disclosure;

FIG. 8B is a block diagram of an example generative language model that includes a transformer encoder-decoder suitable for use in implementing at least some implementations of the present disclosure;

FIG. 8C is a block diagram of an example generative language model that includes a decoder-only transformer architecture suitable for use in implementing at least some implementations of the present disclosure;

FIG. 9 is a block diagram of an example computing device suitable for use in implementing at least some implementations of the present disclosure;

FIG. 10 is a block diagram of an example data center suitable for use in implementing at least some implementations of the present disclosure.

### DETAILED DESCRIPTION

This disclosure relates to systems and methods for dynamically configuring, deploying, and executing AI models within containerized environments. For example, systems and methods in accordance with the present disclosure can generate customized AI model instances, generate software components that interact and/or otherwise interface with AI models, and configure runtime environments for executing the software components. The containerized execution environment can be instantiated to provide computing resources, manage dependencies, and/or support AI model execution. The systems can dynamically configure computing environments to improve AI model deployment and execution.

Some techniques for deploying AI models fail to incorporate dynamic customization, containerized execution, and/or computing resource management. These methods often rely on static infrastructure settings (e.g., fixed resource allocations, predefined execution environments, manual dependency management), leading to inefficient execution of AI models and software components. Additionally, traditional systems lack mechanisms for configuring execution environments based on AI model requirements. This can lead to performance inefficiencies (e.g., latency in model execution, bottlenecks in inference pipelines, among others), increased deployment complexity (e.g., manual configuration of execution environments, dependency conflicts, lack of integration with containerized workflows, among others), and/or resource underutilization (e.g., idle computing resources, excessive memory consumption, unnecessary GPU and/or CPU allocation, among others). The technical limitations relate to how these systems manage AI model customization, software component deployment, and/or execution resource allocation. For example, inadequate resource provisioning can result in execution failures and/or reduced performance, while poor runtime environment configurations can prevent effective AI model interaction. The improved implementations described herein address these limitations by dynamically generating AI model instances, deploying software components, and/or instantiating containerized execution environments to support AI-driven operations.

Systems and methods in accordance with the present disclosure provide improved AI model customization, software component execution, and containerized deployment by dynamically managing execution environments. For example, a customized AI model instance can be generated based on received model updates (e.g., modifying parameters, integrating new datasets, and/or applying specific techniques for fine-tuning and/or domain adaptation), and a software component can be generated to process inputs and interact with the AI model instance. The software component (e.g., inference engine, software module, utility, script, and/or any other computational resource) can be deployed within a runtime environment that provides execution dependencies, computing resources, and containerized isolation. The deployment (e.g., containerization) can be dynamically configured based on AI model customizations, computational resource availability, and/or execution performance requirements. These processes can be integrated with a container orchestration platforms and/or dynamic resource allocation frameworks.

The systems and methods can dynamically adjust deployment configurations and/or execution environments based on AI model updates and resource constraints. For example, an execution environment for an AI model can be instantiated within a cloud-based or on-premises infrastructure, and/or resource allocations (e.g., CPU, GPU, memory) can be updated based on the computational requirements of the model. Additionally, the deployment process can be augmented by selecting computing nodes and/or clusters that provide the performance for executing the AI model.

In some implementations, the systems and methods can provide an interactive interface allowing users to configure AI model deployment settings and select execution environments. For example, a user interface can present selectable options for configuring AI model parameters, allocating computing resources, and/or selecting container execution environments. The selected configurations can be used to dynamically generate a containerized AI model deployment to facilitate execution of AI-driven applications.

The systems and methods described herein can be used for a variety of applications, such as cloud-based AI model deployment, edge AI execution, AI-driven analytics, model inference serving, and/or distributed computing for AI applications. For example, the systems can deploy AI models in containerized environments (e.g., cloud-based infrastructures, edge computing platforms, distributed container orchestration systems) with dynamically allocated computing resources, allowing scalable and adaptable AI-driven applications. The deployment environments can be instantiated across cloud platforms, data centers, and/or edge devices, supporting AI-driven workloads with minimal manual configuration. These implementations address the limitations of traditional AI deployment systems by facilitating improved AI model customization, software component execution, and/or dynamic resource management in containerized environments.

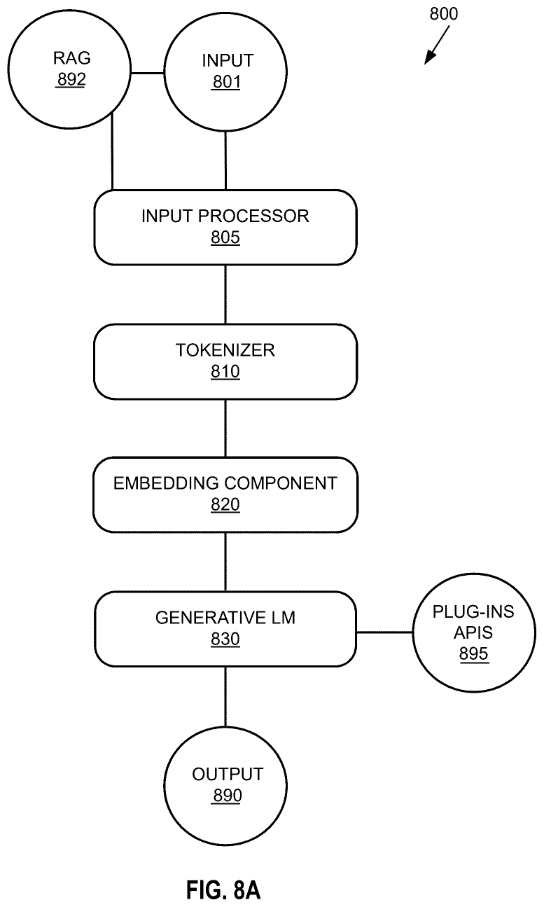

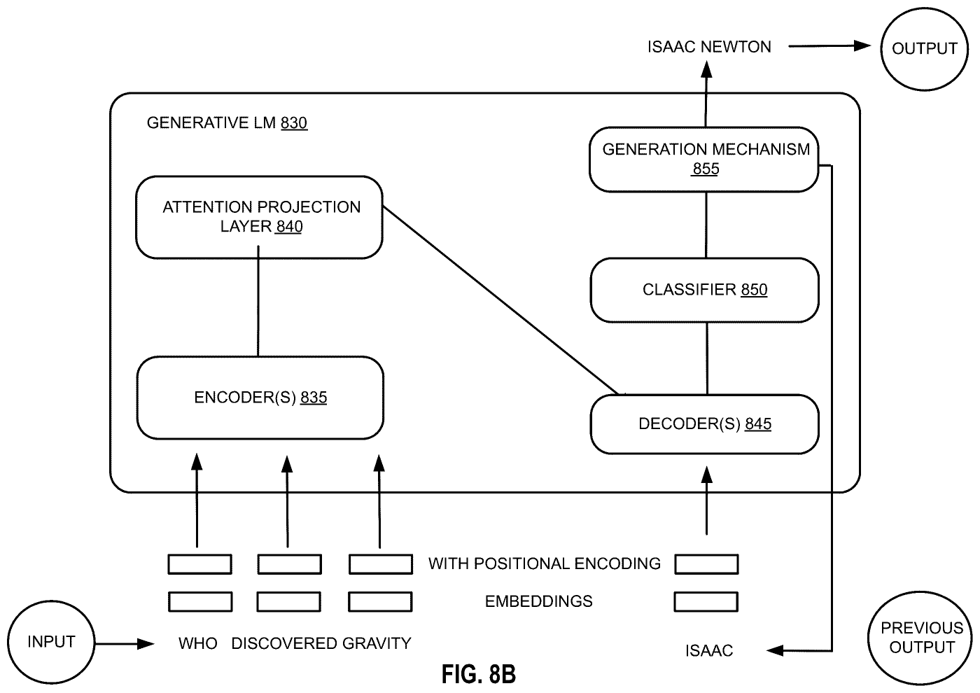

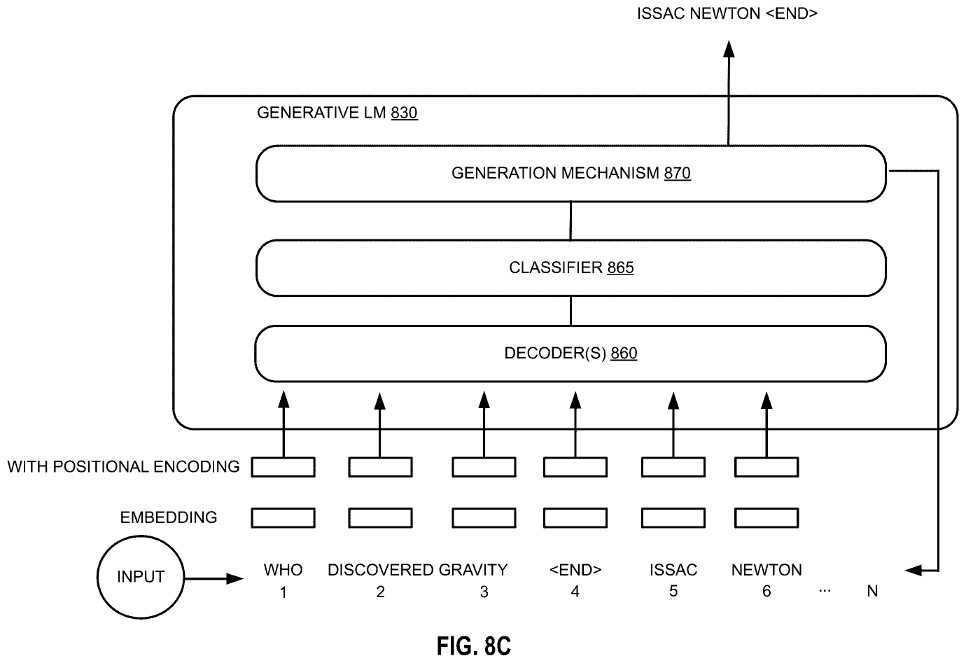

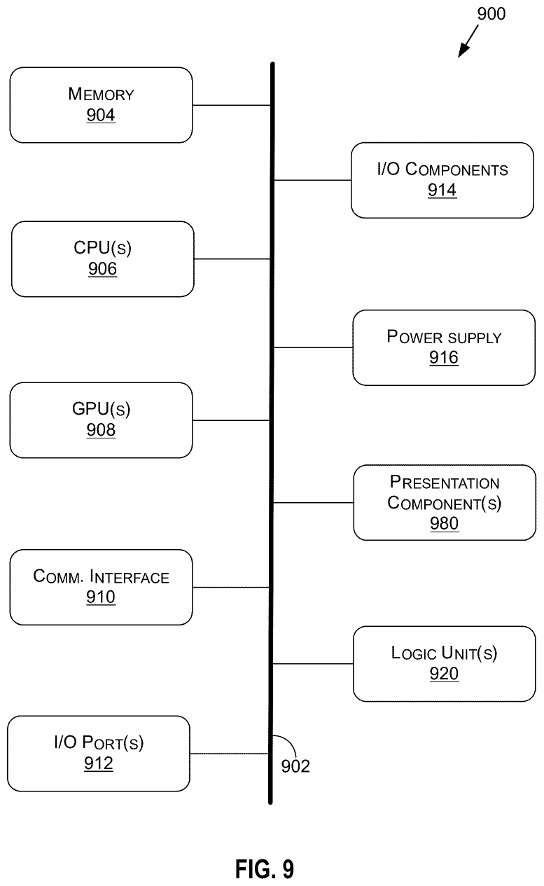

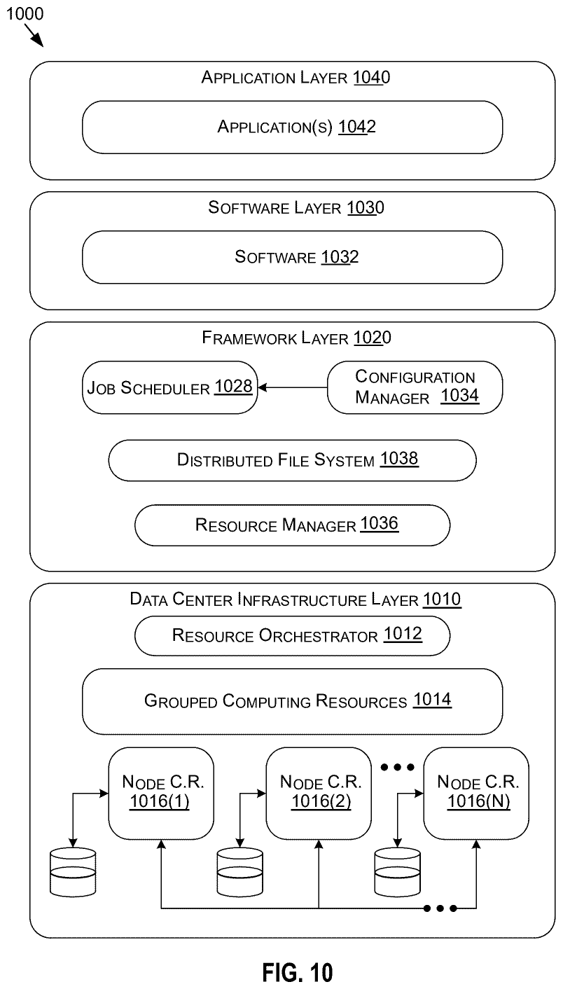

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 800 of FIG. 8A, example generative language model (LM) 830 of FIGS. 8B-8C, example computing device 900 of FIG. 9, and/or example data center 1000 of FIG. 10.

The system 100 can implement at least a portion of a model customization pipeline, such as but not limited to a model deployment pipeline, a model adaptation pipeline, and/or a model execution pipeline. The system 100 can be used to customize AI models for execution in containerized environments and/or deploy software components configured for executing AI-driven operations by any of various systems described herein, including but not limited to AI inference systems, autonomous systems, edge computing systems, multi-cloud deployment systems, enterprise AI model management systems, large-scale training systems, and/or virtualized execution environments.

Generally, the model customization pipeline can include operations performed by the system 100. For example, the model customization pipeline can include any one or more of an interfacing stage, an instantiation stage, a component generation stage, and/or a packaging stage. Each stage of the model customization pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the model customization pipeline) can receive at least one customization of at least one artificial intelligence (AI) model corresponding to a base instance. In some implementations, implementing the model customization pipeline can include the system 100 generating a customized instance of the at least one artificial intelligence (AI) model by updating the base instance of the at least one AI model based on the at least one customization. Additionally, implementing the model customization pipeline can include the system 100 generating a software component configured to perform at least one operation using the customized instance of the at least one AI model. In some implementations, implementing the model customization pipeline can include the system 100 packaging the software component and the customized instance of the at least one AI model into a first container instance. Additionally, implementing the model customization pipeline can include the system 100 deploying the software component within a runtime environment. Thus, the model customization pipeline can reduce latency in AI model adaptation by facilitating containerized execution environments to be instantiated with pre-configured dependencies, reduce manual intervention by facilitating model customization and deployment operations within software-defined environments, and improve computational resource allocation by provisioning processing systems and memory based on workload requirements.

Generally, the system 100 can provide a container in a running environment (e.g., a cloud-based execution platform, an edge computing node, and/or a local virtualized infrastructure) and/or provide a static container image (e.g., pre-packaged static environment) where the AI model and software components can be pre-configured for deployment. In some implementations, providing a container in a running environment can be performed when execution environments use on-demand provisioning of computational resources (e.g., dynamically allocating processing, memory, and/or storage). That is, the system 100 can instantiate a container instance within a deployment system and provision computing resources dynamically. In some implementations, providing a static container image can be performed when a prebuilt, portable execution environment is desired. That is, the system 100 can generate a self-contained package for deployment across multiple environments. Additionally, the interfacing stage, the instantiation stage, and the component stage can be performed similarly in both implementations. However, the packaging stage can differ based on whether the software component is embedded within a container image or deployed as part of a runtime-managed environment.

For example, when providing a static container image, the system 100 can package the software component and the customized instance of the at least one AI model into a container image (e.g., an immutable execution environment). In this example, the system 100 can deploy the software component within a runtime environment (e.g., execute the AI model and/or software component within a managed compute instance). In another example, when providing a container in a running environment, the system 100 can instantiate the first container instance by loading the container image into an execution environment and allocating computing resources dynamically (e.g., scheduling execution using a container orchestration platform). In this example, the system 100 can provide to a deployment system (e.g., a cloud container service, a local execution cluster, and/or a distributed edge framework), the container image (e.g., a prebuilt AI inference container, a fine-tuned model container, and/or a multi-model execution container) configured for execution of the software component in a container instance.

In some implementations, the interfacing stage can be the stage in the model customization pipeline in which the system 100 can receive user input defining modifications to an AI model, retrieve predefined configurations, and/or access external data sources for model adaptation. The system 100 can include at least one interface system 104. The interface system 104 can receive at least one customization 102 of at least one artificial intelligence (AI) model corresponding to a base instance. That is, the interface system 104 can process customization requests, validate input parameters, and forward customization data for model adaptation. For example, during the interfacing stage, the interface system 104 can present a user interface for selecting fine-tuning options, upload additional datasets, and/or apply predefined model configuration profiles. The base instance can be a pre-trained AI model, a foundation model, a partially fine-tuned model, and/or any model variant designed for further adaptation (e.g., Pre-trained Transformer (ChatGPT), DALL-E, Stable Diffusion, Large Language Model Meta AI (LLAMA), BERT, T5, Vision Transformers (ViTs), and/or any multi-modal AI model). That is, the base instance can serve as an initial state for further refinement through additional training, prompt-based customization, and/or architectural modifications.

In some implementations, the interfacing stage can include the interface system 104 providing (e.g., via an SDE and/or any web-based deployment portal, cloud-based container management system) a user interface including a plurality of selectable elements. That is, the user interface can be a workspace where the user can customize models and deploy inference engines. For example, at least one first selectable element of the plurality of selectable elements can correspond to configuring and deploying a plurality of software components. In this example, the interface system 104 can provide a selection interface for choosing compute resources (e.g., GPU instances), containerized environments, and/or runtime configurations for deployment. In another example, at least one second selectable element of the plurality of selectable elements can correspond to updating at least one model parameter. In this example, the interface system 104 can provide interactive fields for modifying hyperparameters, selecting fine-tuning datasets, and applying model-specific improvements. Thus, the user interface can allow the user to perform customizations (e.g., the customization 102) and deployment (e.g., the deployment 112).

Additionally, the interface system 104 can receive, via the SDE from the at least one first selectable element, a request to configure and deploy the software component. That is, the interface system 104 can interpret the selection as a deployment action and pass the execution parameters to the instance generator 106. For example, receiving the at least one customization 102 can include receiving, from the at least one second selectable element, the at least one model parameter (e.g., fine-tuning, prompt tuning, updating hyperparameters) to update the base instance of the at least one AI model. In some implementations, the user interface can include at least one content item (e.g., selection menus for compute resources, dropdown lists for container environments, input fields for model configurations, graphical status indicators, confirmation dialogs, and/or any real-time deployment status panels) corresponding to deployment and configuration information of the software component. That is, the interface system 104 can provide a user interface including interactive elements for selecting execution environments, modifying software dependencies, and confirming resource allocations. For example, the deployment and configuration information can include at least one of (i) compute information (e.g., NVIDIA A100 (40 GiB), 1 GPUs×12 CPUs, 120 GiB), (ii) container information (e.g., Python version: 3.10; CUDA version: 12.0.1), or (iii) file information (e.g., Notebook llama3dpo). In this example, the compute information can be displayed in a selection panel with hardware specifications and pricing details, the container information can be shown in a settings interface detailing runtime versions and dependencies, and/or the file information can be managed through an interactive file browser allowing users to select and upload model configurations.

In some implementations, the at least one customization 102 of an AI model can include applying fine-tuning to the AI model (e.g., base instance) with domain-specific data, updating weights, parameters, and/or guardrails of the AI model to cause a refined performance, applying techniques to the AI model such as supervised fine-tuning, LoRA, and/or P-tuning, embedding knowledge distillation, pruning redundant parameters, structural adaptation of network layers, and/or any improvement technique improving inference efficiency or accuracy. That is, at least one customization 102 of an AI model can be a process for customizing a base AI model to meet specific operational requirements, integrating task-specific datasets, and/or refining its decision-making. In some implementations, the interface system 104 can receive and/or otherwise obtain the at least one customization 102 by parsing user input from an application programming interface (API), retrieving preset configurations from storage, and/or ingesting external training datasets. The receiving and/or obtaining can be performed asynchronously, synchronously, in response to API requests, and/or triggered by user interaction with a customization dashboard. For example, the interface system 104 can process a command to modify model hyperparameters, analyze uploaded domain-specific data for fine-tuning, and/or validate selected customization parameters against computational constraints.

In some implementations, the instantiation stage can be the stage in the model customization pipeline in which the system 100 can apply customization parameters to a base instance to generate a modified AI model instance. The system 100 can include at least one instance generator 106. The instance generator 106 can generate a customized instance of the at least one AI model by updating the base instance of the at least one AI model based on the at least one customization. The customized instance can represent the customized version of the base AI model (e.g., modifying parameters, integrating new datasets, applying specific techniques for fine-tuning or domain adaptation, adjusting model hyperparameters, modifying tokenization processes, implementing pruning techniques, and/or any structural modifications to enhance model efficiency). That is, the instance generator 106 can update neural network weights (e.g., updating transformer attention scores, updating convolutional filter values, recalibrating batch normalization statistics, and/or any weight reinitialization processes) based on new training data, reconfigure parameters (e.g., updating dropout rates, updating learning rate schedules, updating regularization factors) to implement guardrails, replace layers (e.g., substituting activation functions, updating residual connections, updating attention heads) and/or embeddings (e.g., updating positional encodings, updating word vector representations, updating learned semantic mappings) in the base AI model, applying transfer learning adaptations, applying adversarial training constraints, and/or enforcing quantization techniques.

For example, updating the base instance can include the instance generator 106 performing at least one of fine-tuning (e.g., supervised fine-tuning (SFT), P-tuning, low-rank adaptation (LoRA)), applying prompt tuning, or updating at least one model parameter (e.g., applying domain-specific vocabulary embeddings, adjusting temperature scaling, modifying layer-wise normalization factors) of the base instance. In this example, the instance generator 106 can store the updated model state, verify structural integrity post-modification, or apply validation tests to ensure functionality. In some implementations, the instance generator 106 can generate and/or otherwise construct the instance by loading pretrained weights, executing transformation functions, and/or updating initialization parameters.

In some implementations, generating can include the instance generator 106 constructing a computational graph representation, compiling intermediate execution states, and/or allocating memory for modified model structures. That is, the customized instance can be generated by instantiating updated neural network layers, applying model checkpointing strategies, and/or performing gradient recalibration procedures. For example, the instance generator 106 can load domain-adapted parameter sets, inject task-specific constraints, and configure multi-modal processing capabilities. In another example, the instance generator 106 can embed user-defined constraints into training procedures, integrate reinforcement learning updates, and/or reconfigure processing workflows.

The instance generator 106 can include any one or more artificial intelligence models (e.g., machine learning models, supervised models, neural network models, deep neural network models), rules, heuristics, algorithms, functions, or various combinations thereof to perform operations including generating, modifying, and/or adapting AI models based on provided customization parameters, such as hyperparameter tuning, weight adjustments, embedding replacements, and/or fine-tuning specific layers. That is, the AI model(s) can be a neural network and/or machine-learning (ML) model trained to modify base models for domain-specific adaptation. In some implementations, the instance generator 106 can output customized model instances (e.g., fine-tuned neural networks, transformer models, hybrid inference engines, and/or any variations thereof). For example, the output can be a model adapted to process domain-specific queries with adjusted response generation parameters. In another example, the output can be a model trained for real-time inference with improved computational efficiency. In some implementations, the input customization parameters can be provided to instance generator 106 to perform structured model modifications such as layer reconfiguration, pruning, and/or model merging.

In some implementations, the instance generator 106 can maintain, execute, train, update, and/or otherwise process, refine, or apply one or more artificial intelligence (AI) models during the instantiation stage. In some implementations, the AI model(s) can include any type of probabilistic, transformer-based, and/or graph-based AI model capable of generalizing input data patterns (e.g., autoregressive transformers, graph neural networks) to improve structured output generation. For example, the AI model(s) can be trained and/or updated to refine embeddings, adjust token representations, and adapt to distributional changes, among other modifications. The AI model(s) can be or include a transformer-based model (e.g., a generative pre-trained transformer (GPT) model, a bidirectional encoder representations from transformers (BERT)). The machine-learning model(s) can be or include a convolutional neural network (CNN) model, in some implementations. The instance generator 106 can execute the AI model to generate outputs. The instance generator 106 can receive data to provide as input to the AI model(s), which can include training datasets, domain-specific corpora, pre-processed embeddings, and/or any user-provided customization parameters.

In some implementations, the instance generator 106 can execute one or more AI models by utilizing a modeling framework to improve the performance of the AI model during the instantiation stage. The framework can include implementing techniques such as gradient descent, backpropagation, and distributed training on large-scale datasets. The AI model(s) can incorporate mechanisms such as dropout regularization and weight pruning to maintain efficiency and prevent overfitting. For example, during execution, the instance generator 106 can partition input data into mini-batches, apply loss functions, and update model parameters iteratively. The AI models can support inference operations that include processing feature vectors, transforming raw input data, and generating probabilistic predictions and/or metrics. The instance generator 106 can integrate hardware accelerators such as GPUs or TPUs to improve computational demands, for example, when processing high-dimensional input sequences for real-time inference.

In some implementations, the instance generator 106 can evaluate trained models using various metrics (e.g., precision, recall, and/or F1 score) and/or any computational performance measures to determine readiness for deployment and/or inference operations. The evaluation can include analyzing model performance on validation datasets, testing datasets, or real-world data inputs to assess consistency and robustness. For example, the instance generator 106 can compare model predictions against ground truth data to determine accuracy metrics, error rates, and/or confidence intervals. In another example, the instance generator 106 can track performance variations over multiple evaluation cycles to identify potential degradation and/or drift in model accuracy. The evaluation can include the instance generator 106 applying techniques such as cross-validation, Monte Carlo simulations, and/or adversarial testing to measure resilience against noise or distributional shifts. In some implementations, the instance generator 106 can generate performance metrics and/or data structures including metric values, confusion matrices, and/or calibration plots to identify model effectiveness. The performance metrics and/or data structures can be used to facilitate retraining procedures, model adjustments, and/or fine-tuning processes if evaluation criteria are not met. The instance generator 106 can integrate threshold-based criteria, such as enforcing an F1 score above a predefined value, before permitting the AI model(s) to be deployed for inference. In some implementations, model evaluation can include automated testing pipelines that perform predefined test cases, analyze false positive and false negative rates, and/or apply statistical significance tests to validate improvements.

In some implementations, the instance generator 106 can include at least one AI model. The AI model(s) can include an input layer, an output layer, and/or one or more intermediate layers, such as hidden layers, which can each have respective nodes. For example, the input layer can process model checkpoint data, instance configuration files, and/or software component dependencies. For example, the output layer can generate structured inference outputs formatted for execution in a containerized runtime environment. For example, the intermediate layers can apply sequence encoding techniques, adjust model hyperparameters, and/or reconfigure activation functions to support improved inference operations.

In some implementations, the system 100 can configure (e.g., train, update, fine tune, apply transfer learning to) the AI model(s) by modifying or updating one or more parameters, such as weights and/or biases, of various nodes of the AI model(s) responsive to evaluating estimated outputs of the AI model(s) (e.g., generated in response to receiving training examples in a training dataset, such as a training dataset). The instance generator 106 can be or include various neural network models, including models that can for operating on or generating data including models that operate on or generate deployment metadata, execution traces, or optimization recommendations.

In some implementations, the instance generator 106 can be configured (e.g., trained, updated, fine-tuned, has transfer learning performed, etc.) based at least on the training data of the at least one training dataset (e.g., model execution logs, deployment configuration datasets, and/or system profiling data). For example, one or more example inference requests and/or execution traces of the training data can be applied (e.g., by the system 100 and/or in a pre-training and/or tuning process performed by the system 100 or another system) as input to the instance generator 106 to cause the instance generator 106 to generate an estimated output. The estimated output can be evaluated and/or compared with expected runtime behavior (or predicted system performance) of the training data that correspond with the one or more example inference requests and/or execution traces, and the AI model(s) of the instance generator 106 can be updated based at least on the performance metrics and/or improvement heuristics. For example, based at least on an output of execution profiling, one or more parameters (e.g., weights and/or biases) of the AI model(s) of the instance generator 106 can be updated.

In some implementations, the instance generator 106 can implement and/or otherwise facilitate a pre-training in which the AI model(s) is trained on large-scale, unstructured datasets to learn foundational representations (e.g., model performance distributions, workload scheduling behaviors, and/or computational efficiency trends). The pre-training can include self-supervised learning techniques such as masked token prediction, next-token prediction, contrastive learning, and/or denoising objectives to develop generalized feature representations. For example, the AI model(s) can be exposed to large corpora of execution traces, system telemetry logs, and/or deployment workflows to extract statistical patterns, semantic relationships, and/or latent structures. In another example, the AI model(s) can apply unsupervised clustering techniques to identify recurrent patterns and correlations in the training data (e.g., inference response distributions, resource allocation patterns, and/or improvement strategies). The pre-training phase can include updating model parameters based on loss functions computed from predicting missing or corrupted data points. The instance generator 106 can apply distributed training techniques, including data parallelism, model parallelism, and/or pipeline parallelism, to improve the computational efficiency of pre-training. The output of the pre-training phase can be used to initialize the AI model(s) for subsequent fine-tuning on specific tasks.

In some implementations, the instance generator 106 can implement and/or otherwise facilitate fine-tuning in which the AI model(s) is updated to specific tasks (e.g., containerized inference, workload balancing, and/or execution scaling) using domain-specific training datasets (e.g., improved deployment logs, structured inference profiles, and/or latency-aware execution graphs). The fine-tuning process can include supervised learning, reinforcement learning, and/or contrastive learning to refine the pre-trained representations. For example, the instance generator 106 can adjust model weights based on inference response times, memory utilization, and/or computational overhead. The instance generator 106 can update the AI model(s) by adjusting weights, biases, and/or layer-specific parameters based on task-specific loss functions. For example, fine-tuning can include backpropagation-based updates using labeled datasets where the AI model(s) can be trained to minimize classification errors, prediction uncertainties, and/or inference inconsistencies. In some implementations, fine-tuning can be performed using techniques such as low-rank adaptation (LoRA), adapter layers, and/or selective parameter freezing to reduce computational costs while preserving generalization capabilities. The instance generator 106 can iteratively evaluate the AI model(s) on validation datasets (e.g., structured inference requests, model efficiency benchmarks, and/or system profiling data) to track performance changes, mitigate overfitting, and/or determine convergence criteria. Fine-tuning outputs can be evaluated against reference benchmarks (e.g., cloud-based inference latencies, hardware-specific improvement targets, and/or real-time system constraints) to assess task alignment, efficiency improvements, and/or robustness against adversarial inputs.

In some implementations, the instance generator 106 can implement and/or otherwise facilitate retrieval-augmented generation (RAG) models to improve output quality of the AI model(s) by incorporating external knowledge sources. The RAG architecture can include a retrieval system and a generation system, where the retrieval system of instance generator 106 can fetch relevant documents, embeddings, or structured data (e.g., execution logs, deployment heuristics, workload improvement strategies, and/or any inference response records) from knowledge bases (e.g., system profiling databases, cloud infrastructure logs, model performance archives, and/or any workload prediction models), and the generation system of instance generator 106 can synthesize responses using retrieved content. The instance generator 106 can utilize vector search techniques such as FAISS, approximate nearest neighbor (ANN) search, and/or BM25 ranking to identify relevant retrieval candidates. For example, the AI model(s) can retrieve contextually relevant deployment parameters (e.g., hardware configurations, scaling policies, workload partitioning rules, and/or any execution improvement heuristics) from an indexed database and use the retrieved content as additional input for generating responses. In some implementations, the instance generator 106 can dynamically update retrieval parameters based on query complexity, information density, and/or response ambiguity. The retrieval process can be reinforced using feedback mechanisms, where low-confidence generations trigger additional retrieval iterations. The instance generator 106 can integrate hybrid approaches that combine parametric memory from the AI model(s) with non-parametric retrieval sources to balance computational efficiency and factual accuracy.

In some implementations, the instance generator 106 can implement and/or otherwise facilitate a sparse expert-based model architecture. The AI model(s) can utilize a Mixture of Experts (MoE) framework, where a subset of expert networks can be dynamically activated per inference step based on input characteristics. For example, when an inference request (e.g., a batch-processing task) is received, the AI model(s) can activate only the relevant expert networks improved for memory-efficient batch execution. The MoE structure can include multiple specialized sub-networks, at least one (e.g., each) trained on different aspects of data processing, and a gating mechanism that selects the relevant experts for a given query. In some implementations, the instance generator 106 can include improvements such as multi-head latent attention, which reduces memory overhead by compressing and reconstructing key-value pairs dynamically, minimizing cache storage requirements during inference. The AI model(s) can integrate both local and global attention mechanisms, where local attention can process immediate token relationships and global attention can capture long-range dependencies. Additionally, the AI model(s) can implement soft token merging to reduce redundant input tokens and dynamic token inflation to restore critical details during later processing stages. The instance generator 106 can further improve inference performance by employing hardware acceleration techniques, including tensor parallelism and/or memory-efficient caching strategies. The system 100 can execute the sparse expert-based model architecture (e.g., the AI model(s)) for natural language processing, reasoning-based tasks, structured data transformation, and/or multimodal data generation.

In some implementations, the component generation stage can be the stage in the model customization pipeline in which the system 100 can create a deployable software component from the customized AI model instance. The system 100 can include at least one component generator 108. The component generator 108 can generate a software component (e.g., inference engine, software module, utility, script, and/or any other computational resource) configured to perform at least one operation using the customized instance of the at least one AI model. That is, the component generator 108 can transform the customized AI model instance into an executable form, integrating dependencies and configuring execution parameters. For example, during the component generation stage, the component generator 108 can compile executable logic, link model weights, and/or define API endpoints for inference requests.

Generally, the software component can be an inference engine, software module, utility, script, and/or any other computational resource that utilizes the customized instance of the at least one AI model to perform AI-driven operations. The software component can be generated to execute within a containerized environment, supporting inference requests, batch processing, and/or real-time or near real-time interactions. For example, the software component can include a model-serving API that exposes endpoints for receiving input data, invoking the customized AI model, and returning inference results. In another example, the software component can integrate with distributed computing frameworks to facilitate model execution across multiple hardware accelerators, including GPUs and TPUs. The software component can be structured to support containerized execution, facilitating deployment across cloud platforms, on-premises servers, and/or local development environments.

In some implementations, the container instance can include the runtime environment configured to execute the software component (e.g., executable program that uses the customized AI model to perform operations, such as processing text, generating images, analyzing data streams, and/or any ML-based transformation tasks) using the customized instance of the at least one AI model. That is, the runtime environment can be a software layer (e.g., an execution layer within the container instance that abstracts hardware resources and provides essential software dependencies) providing the tools and infrastructure to perform executions (e.g., Dependencies: libraries, frameworks, APIs, and/or drivers; Configuration Files: parameters and settings of the hardware and/or software; Executable Environment: lightweight OS to run the application in isolation). For example, the runtime environment includes containerized Python environments, NVIDIA CUDA for GPU acceleration, and ONNX runtimes for cross-platform model execution. In this example, the dependencies can include TensorRT, PyTorch, TensorFlow, and/or MLflow, a configuration file can include model weight paths, inference parameters, and batch size settings, and the executable environment can be a containerized Linux distribution supporting AI workloads.

Additionally, the container instance can correspond to an instantiation of a container image (e.g., a pre-packaged, executable unit that includes the software component, dependencies, and execution environment). That is, the container image can be configured to execute in an execution environment that provisions at least one computing resource (e.g., CPU, GPU, memory, storage, network access, shared compute clusters, accelerators, and/or any AI-dedicated hardware) for executing the container instance. For example, the component generator 108 can embed execution logic in an image (e.g., instructions for creating a container), specify hardware acceleration flags, and configure entry points for deployment in cloud or on-premises environments. In some implementations, generating the software component can include the component generator 108 generating software logic (e.g., executable code, services, scripts, APIs, and/or processing frameworks) configured to receive at least one input and apply the at least one input to the customized instance of the at least one AI model to cause the customized instance to generate at least one output. That is, the software component can facilitate inference execution, perform user requests, and route inputs through the customized AI model instance. For example, an inference API processes text queries by tokenizing input, passing it through a transformer-based model, and returning a response.

The component generator 108 can generate the software component as an inference engine configured to execute the customized instance of the at least one AI model for processing input data and generating outputs (e.g., predictions, classifications, recommendations). The component generator 108 can generate the inference engine as a software framework that loads the customized AI model into memory, processes input data (e.g., normalizing or resizing images for computer vision tasks), and applies the AI model to produce output. The inference engine can manage execution workflows by allocating memory for model parameters, handling data transformations, and performing model inference computations. The component generator 108 can configure the inference engine to process requests using various execution backends, including hardware acceleration libraries (e.g., CUDA for NVIDIA GPUs) and software-based execution environments. For example, the component generator 108 can generate the inference engine to use TensorRT for improved execution of AI models on GPU architectures. In another example, the inference engine can be generated to use ONNX Runtime for cross-platform execution of AI models across cloud, on-premises, and/or edge computing environments.

The component generator 108 can generate the software component to operate within the runtime environment of the first container instance, allowing execution of inference requests using the customized AI model. The runtime environment can include dependencies (e.g., model execution frameworks, data processing libraries) for the inference engine to process input data and generate output. The component generator 108 can configure the software component to expose application interfaces for interaction with external systems, such as APIs for processing inference requests. The inference engine can support batch processing to handle multiple inference requests concurrently and/or improve computational resource usage. The component generator 108 can further generate the inference engine with model-specific execution configurations, such as precision modes (e.g., floating point or quantized execution) and memory allocation strategies to manage model state across inference requests. The inference engine can process inputs, apply the customized AI model, and/or generate structured output within the execution environment of the first container instance.

In some implementations, the packaging stage can be the stage in the model customization pipeline in which the system 100 can encapsulate the software component, model weights, and dependencies into a deployable format. The system 100 can include at least one packaging system 110. When providing the container in a running environment, the packaging system 110 can bundle the inference engine and model into a container instance configured for execution in cloud or on-premises environments. That is, the packaging system 100 can package (e.g., containerize) the software component and the customized instance of the at least one AI model into a first container instance. For example, the packaging system 110 can generate a standardized deployment artifact that ensures compatibility with target execution environments. In this example, during the packaging stage, the packaging system 110 can create a container image, define resource constraints, and/or register the image with a container registry. In some implementations, the packaging system 110 can compress model weights, improve execution graphs, and/or register version metadata and/or otherwise generate deployment manifests specifying runtime parameters. The packaged container can be stored in a registry for retrieval by deployment systems (i.e., orchestration platforms, model-serving frameworks, and/or container management systems, e.g., Kubernetes-based clusters, inference-serving engines, or cloud-based model hosting services). That is, the containerized AI model can be pulled and executed dynamically.

In some implementations, packaging the software component and the customized instance can include generating the container image (e.g., a preconfigured filesystem containing the software component, execution dependencies, model artifacts, and/or runtime libraries) including the software component, the customized instance of the at least one AI model, and the runtime environment configured to execute the software component. That is, the packaging system 110 can define the execution context of the inference engine within the container image, specify dependency layers (e.g., execution frameworks, computational libraries), and structure the image for deployment on compatible container orchestration platforms. Additionally, the packaging system 110 can instantiate the first container instance (e.g., launch the container instance) by loading the container image into the execution environment and allocating the at least one computing resource for execution. For example, the packaging system 110 can retrieve the container image from a container registry, initialize execution contexts, mount storage volumes for persistent data access, and configure network settings for external communication.

Generally, a set of containers executing within a shared execution environment can be referred to as “pods.” In some implementations, the packaging system 110 can configure pods to manage multiple container instances, where at least one (e.g., each) container shares networking, storage, and runtime configurations. That is, the packaging system 110 can structure containerized workloads into pods, facilitating resource allocation, execution scheduling, and/or dependency resolution within container orchestration platforms. The system 100 can configure the pod to execute multiple containers that communicate through a shared network interface, allowing intra-pod communication without external routing mechanisms. In some implementations, the packaging system 110 can define pod-level configurations that establish runtime constraints, including memory limits, CPU allocation, and/or inter-container communication policies. For example, a pod can include at least one primary container executing a container instance and/or inference engine and an auxiliary container performing monitoring, logging, and/or data preprocessing operations.

In some implementations, the packaging system 110 can register pods within a deployment system that manages containerized execution workloads. That is, the packaging system 110 can define pod manifests specifying execution parameters, service discovery configurations, and/or storage volume mappings. The pod manifest can include specifications for mounting persistent storage, exposing internal endpoints, and associating metadata with running instances. The system 100 can allocate pods dynamically based on resource availability, execution priority, and model inference demands. For example, a pod can be instantiated with a specific GPU type (e.g., NVIDIA H100) and preconfigured to retrieve model artifacts from a specified object storage location. The packaging system 110 can coordinate and/or otherwise communicate with an orchestration layer to monitor pod lifecycle events, manage failures, and/or facilitate executions of AI models (e.g., customized instances).

In some implementations, the packaging system 110 can implement pod-based scaling mechanisms to support dynamic inference workloads. That is, the system 100 can initiate pod autoscaling policies based on predefined metrics such as inference request rates, resource consumption thresholds, and/or execution latency measurements. The packaging system 110 can instantiate additional pods in response to increased inference demand and terminate idle pods to improve resource utilization. In some implementations, the system 100 can maintain a distributed inference architecture by assigning AI model replicas to multiple pods executing across different compute nodes.

In some implementations, the packaging stage can be the stage in the model customization pipeline in which the system 100 can prepare the software component for deployment 112 by defining runtime execution parameters and resource constraints. The system 100 can include at least one packaging system 110. The packaging system 110 can deploy the software component within a runtime environment. That is, the packaging system 110 can initiate execution of the deployment 112 by launching the container instance, allocate compute resources (e.g., CPU, GPU, memory) based on predefined configurations, and register execution logs for monitoring model performance. For example, during the packaging stage, the packaging system 110 can define container orchestration rules, apply security policies (e.g., access control, permission configurations), and/or establish runtime monitoring. In some implementations, the packaging system 110 can configure deployment policies and/or otherwise generate execution workflows by specifying runtime parameters, defining service discovery mechanisms, and/or registering inference endpoints. The deployment artifacts can be structured to facilitate reproducibility and integration within environments that manage containerized workloads, providing automated scheduling, resource allocation, and/or execution monitoring. That is, the packaging system 110 can provide a structured execution environment supporting both on-demand and persistent inference workloads. For example, the packaging system 110 can package the software component with predefined execution scripts, generate runtime specifications for workload management platforms, and/or register execution endpoints for external services.

In some implementations, the packaging system 110 can instantiate the first container instance in the execution environment, allocate computing resources, and/or initiate execution of the inference engine. For example, the deployment system can configure runtime parameters, establish networking interfaces, and/or set access policies to facilitate interaction with external services. In some implementations, the deployment 112 can include the packaging system 110 integrating the inference engine with request-handling mechanisms for inference operations. That is, the packaging system 110 can register the inference engine as an executable service, monitor resource utilization, and/or expose API endpoints for processing user input. For example, the deployed inference engine can process inference requests using the customized AI model and return structured outputs based on real-time or near real-time and/or batch execution.

The packaging system 110 can structure containerized workloads into pods, where at least one (e.g., each) pod can include multiple containers that share execution resources, networking configurations, and/or storage volumes. The packaging system 110 can instantiate a pod to execute at least one container instance including a software component and a customized instance of at least one AI model. That is, the packaging system 110 can define execution parameters for at least one (e.g., each) container within the pod, including resource allocation (e.g., GPU, CPU, memory), execution dependencies, and/or network accessibility. The packaging system 110 can generate pod configurations that specify runtime constraints, such as container startup policies, failure recovery mechanisms, and/or inter-container communication rules. In some implementations, the packaging system 110 can assign containers to pods based on workload requirements. For example, the packaging system 110 can structure a pod to include a first container for running an inference engine and a second container for monitoring and logging inference performance.

In some implementations, the packaging system 110 can facilitate and/or otherwise manage pod lifecycle events, including creation, execution, scaling, and/or termination of containerized workloads. That is, the packaging system 110 can define pod specifications that facilitate execution of the software component across distributed environments. The packaging system 110 can package the software component and the customized instance into a pod that integrates with a container management platform. The packaging system 110 can retrieve a predefined pod configuration from a container registry and deploy it dynamically in response to an execution request. In some implementations, the packaging system 110 can facilitate pod scheduling based on available compute resources. For example, the packaging system 110 can deploy a pod containing a software component on a compute instance provisioned with GPU acceleration (e.g., NVIDIA H100) to process inference requests.

In some implementations, the packaging system 110 can implement pod-based workload segmentation to isolate execution environments for different instances of the software component. That is, the packaging system 110 can generate multiple pods for deploying distinct model versions, inference pipelines, and/or auxiliary services (e.g., logging, monitoring, data preprocessing). At least one (e.g., each) pod can include at least one container instance executing and/or otherwise performing a specific function, with defined inter-container communication mechanisms for data exchange. The packaging system 110 can establish pod networking policies that facilitate secure data transmission between containers while maintaining execution isolation. For example, the packaging system 110 can configure a first pod to process incoming inference requests, a second pod to perform post-processing, and a third pod to manage inference result storage. In some implementations, the packaging system 110 can dynamically update pod configurations to process updates in execution demand.

In some implementations, the packaging stage can be the stage in the model customization pipeline in which the system 100 can encapsulate the software component, model weights, and dependencies into a deployable format. The system 100 can include at least one packaging system 110. When providing a static container image (e.g., a pre-packaged static environment), the packaging system 110 can bundle the inference engine and model into a container image that can be stored and later instantiated into a container instance. That is, the packaging system 110 can package (e.g., containerize) the software component and the customized instance of the at least one AI model into a container image (e.g., rather than an active container instance). For example, the packaging system 110 can generate a standardized deployment artifact that ensures compatibility with target execution environments. In this example, during the packaging stage, the packaging system 110 can create a container image, define resource constraints, and/or register the image with a container registry for later retrieval. In some implementations, the packaging system 110 can compress model weights, improve execution graphs, and/or register version metadata while generating deployment manifests specifying runtime parameters. The packaged container image can be stored in a registry, allowing deployment systems to pull the image and instantiate a container instance when requested. That is, the containerized AI model can be retrieved and executed on demand.

In some implementations, packaging the software component and the customized instance can include generating the container image (e.g., a preconfigured filesystem containing the software component, execution dependencies, model artifacts, and/or runtime libraries) including the software component, the customized instance of the at least one AI model, and metadata defining the execution environment. That is, the packaging system 110 can define the execution context of the inference engine within the container image, specify dependency layers (e.g., execution frameworks, computational libraries), and/or structure the image for deployment on compatible container orchestration platforms. Additionally, the packaging system 110 can store the container image in a registry (e.g., rather than immediately instantiating a container instance). For example, the packaging system 110 can register the container image with a container repository, define runtime dependencies, store execution parameters, and/or structure metadata for later deployment. In this example, the container image can be pulled and instantiated into a running container instance when requested.

In some implementations, the packaging stage can be the stage in the model customization pipeline in which the system 100 can prepare the software component for the deployment 112 by defining runtime execution parameters and resource constraints. The system 100 can include at least one packaging system 110. The packaging system 110 can provide the container image (e.g., self-contained software package) to a deployment system for execution (e.g., cause instantiation and running of the packaged components (e.g., software component and customized instance) in an isolated environment) of the software component in a container instance. That is, the packaging system 110 can store the deployment artifact, register the container image in a container registry, and/or define metadata specifying execution configurations for later instantiation. For example, during the packaging stage, the packaging system 110 can define orchestration policies, apply security constraints (e.g., access control, execution privileges), and/or generate runtime specifications for deployment environments.

In some implementations, the packaging system 110 can structure deployment workflows and/or otherwise define execution procedures by specifying resource requirements, registering inference endpoints, and/or facilitating compatibility with containerized workload management platforms. The deployment artifacts can be structured for later retrieval, supporting automated container instantiation, scheduled execution, and/or workload distribution across multiple environments. That is, the packaging system 110 can generate and store a structured execution environment supporting deferred deployment and on-demand instantiation of AI model inference engines. For example, the packaging system 110 can generate a static container image with predefined execution scripts, define runtime specifications for deployment scheduling, and/or register execution configurations for future inference tasks.

In some implementations, deploying the software component within the runtime environment is responsive to receiving a selection of at least one of the plurality of selectable elements. That is, the deployment 112 can include a deployed inference engine responsive to a user selection. For example, the system 100 can present a user interface including selectable options for configuring and launching a containerized execution environment. The selectable elements can include configuration options for the container mode, such as selecting a prebuilt container image with predefined dependencies (e.g., PyTorch, TensorFlow) or specifying a custom container. The user selection can further define computing resources, including GPU instances (e.g., NVIDIA H100, A100, or L40S) and storage capacity. Upon receiving the selection, the system 100 can provision the corresponding execution environment by allocating the selected computing resources and launching a container instance preconfigured with the software component and the customized AI model. The system 100 can also register deployment metadata, such as instance name, pricing information, and/or storage allocation. In some implementations, the system 100 can initiate deployment by invoking a deployment command associated with the selected execution environment, such as deploying the inference engine on a cloud platform and/or an on-premises server.

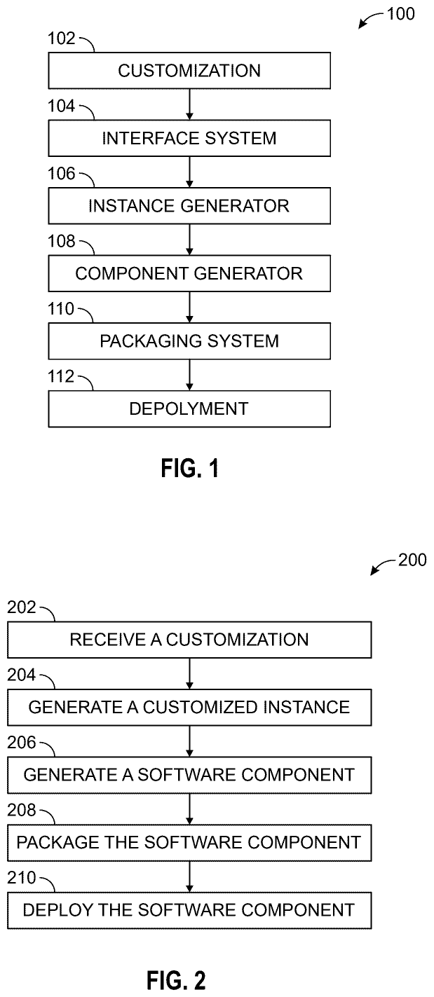

With reference to FIG. 2, an example flow diagram illustrating a method 200 for model customization and deployment in containerized environments in a model customization pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 8A-8C), one or more computing devices or components thereof (e.g., as described in FIG. 9), and/or one or more data centers or components thereof (e.g., as described in FIG. 10).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

Various operations of method 200 can relate to improving the efficiency and adaptability of AI model deployment and execution across different runtime environments. Existing systems often rely on and/or use static model configurations and manual deployment pipelines, which can lead to technical inefficiencies in scaling, resource allocation, and/or model versioning. The existing technological problems can arise when these systems fail to dynamically adapt model execution parameters, resulting in suboptimal inference performance, increased deployment overhead, and/or inconsistencies in model behavior across different execution environments. Method 200 of FIG. 2 can solve these technological problems by implementing containerized packaging, adaptive model execution policies, and/or runtime configuration optimizations, thereby improving model portability, execution efficiency, and/or the reliability of AI-driven inference workflows.

The method 200, at block 202, includes receiving at least one customization of at least one artificial intelligence (AI) model corresponding to a base instance. For example, the customization can be fine-tuning with domain-specific data, modifying weights, parameters, and/or guardrails to refine performance, applying techniques such as supervised fine-tuning, LoRA, and/or P-tuning. The base instance can be a pre-trained transformer (ChatGPT), DALL-E, stable diffusion, large language model Meta AI (LLaMA). In some implementations, the processing circuits can provide, via the SDE, a user interface including a plurality of selectable elements. For example, at least one first selectable element of the plurality of selectable elements can correspond to configuring and/or deploying a plurality of software components. The SDE can provide a workspace where the user can customize models and deployment inference engines. The user interface can allow the user to perform customization and deployment.

Additionally, at least one second selectable element of the plurality of selectable elements can correspond to updating at least one model parameter. In some implementations, the processing circuits can receive, via the SDE from the at least one first selectable element, a request to configure and deploy the software component. That is, receiving the at least one customization can include receiving, from the at least one second selectable element, the at least one model parameter (e.g., e.g., allow fine-tuning, prompt tuning, update hyper parameters) to update the base instance of the at least one AI model. In some implementations, the user interface can include at least one content item corresponding to deployment and configuration information of the software component. For example, the deployment and configuration information can include at least one of (i) compute information (e.g., e.g., NVIDIA A100 (40 GiB), 1 GPUs×12 CPUs, 120 GiB), (ii) container information (e.g., e.g., Python version: 3.10; CUDA version: 12.0.1), or (iii) file information (e.g., Notebook llama3dpo).

The method 200, at block 204, includes generating a customized instance of the at least one AI model by updating the base instance of the at least one AI model based on the at least one customization. In some implementations, the customized instance can be generated by modifying parameters, integrating new datasets, and/or applying specific techniques for fine-tuning or domain adaptation. For example, updating the base instance can include updating neural network weights based on new training data, reconfiguring parameters to implement guardrails, and/or replacing layers and/or embeddings in the model. In some implementations, updating the base instance can include performing at least one of (i) fine-tuning (e.g., e.g., supervised fine-tuning (SFT), P-tuning, low-rank adaptation (LoRA)), (ii) applying prompt tuning, or (iii) updating at least one model parameter of the base instance (e.g., update a parameter with domain-specific data).

The method 200, at block 206, includes generating a software component configured to perform at least one operation using the customized instance of the at least one AI model. For example, the software component can be an inference engine, software module, utility, script, and/or any other computational resource. In some implementations, generating the software component can include generating software logic configured to receive at least one input and apply the at least one input to the customized instance of the at least one AI model to cause the customized instance to generate at least one output. For example, the software logic can include executable code, services, scripts, APIs, and/or processing frameworks.

The method 200, at block 208, includes packaging (e.g., containerizing) the software component and the customized instance of the at least one AI model into a first container instance. That is, the packaging into the container instance can occur when the processing circuits provide a container in a running environment. In some implementations, the processing circuits can package the software component and the customized instance of the at least one AI model into a container image (e.g., self-contained software package). That is, the packaging of the container image can occur when the processing circuits provide a static container image (e.g., in a pre-packaged static environment).

The first container instance can include the runtime environment configured to execute the software component using the customized instance of the at least one AI model. The runtime environment can be a software layer providing the tools and infrastructure to perform executions (e.g., dependencies: libraries, frameworks, APIs, and/or drivers; configuration files: parameters and settings of the hardware and/or software; executable environment: lightweight OS to run the application in isolation). In some implementations, the first container instance can correspond to an instantiation of a container image. That is, the container image can execute in an execution environment configured to provision at least one computing resource (e.g., CPU, GPU, memory, storage, network access) for executing the first container instance. Additionally, packaging the software component and the customized instance can include generating the container image including the software component, the customized instance of the at least one AI model, and the runtime environment configured to execute the software component. In some implementations, packaging the software component and the customized instance can include instantiating (e.g., launch the container instance, implement a pod) the first container instance by loading the container image into the execution environment and allocating the at least one computing resource for execution

The method 200, at block 210, includes deploying the software component within a runtime environment. That is, the deploying can occur when the processing circuits provide a container in a running environment. In some implementations, the processing circuits can provide, to a deployment system, the container image configured for execution (e.g., cause instantiation and running of the packaged components, such as software component and customized instance(s), in an isolated environment) of the software component in a container instance. That is, the providing of the container image can occur when the processing circuits provide a static container image (e.g., in a pre-packaged static environment).

The software component can be an executable program that uses the customized AI model to perform operations. Additionally, the processing circuits can launch a second container instance including a software development environment (SDE) (e.g., a user has access to the SDE within the container instance). In some implementations, the processing circuits can install the at least one AI model in the second container instance. That is, the second container instance can receive the at least one customization prior to generating the customized instance of the at least one AI model. Additionally, installing a local copy of the AI model can allow the SDE to be configured to support customization of the local copy through one or more techniques (e.g., fine-tuning). In some implementations, deploying the software component within the runtime environment can be responsive to receiving a selection of at least one of the plurality of selectable elements. That is, the processing circuits can deploy an inference engine responsive to a user selection.

The systems and methods described herein can be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

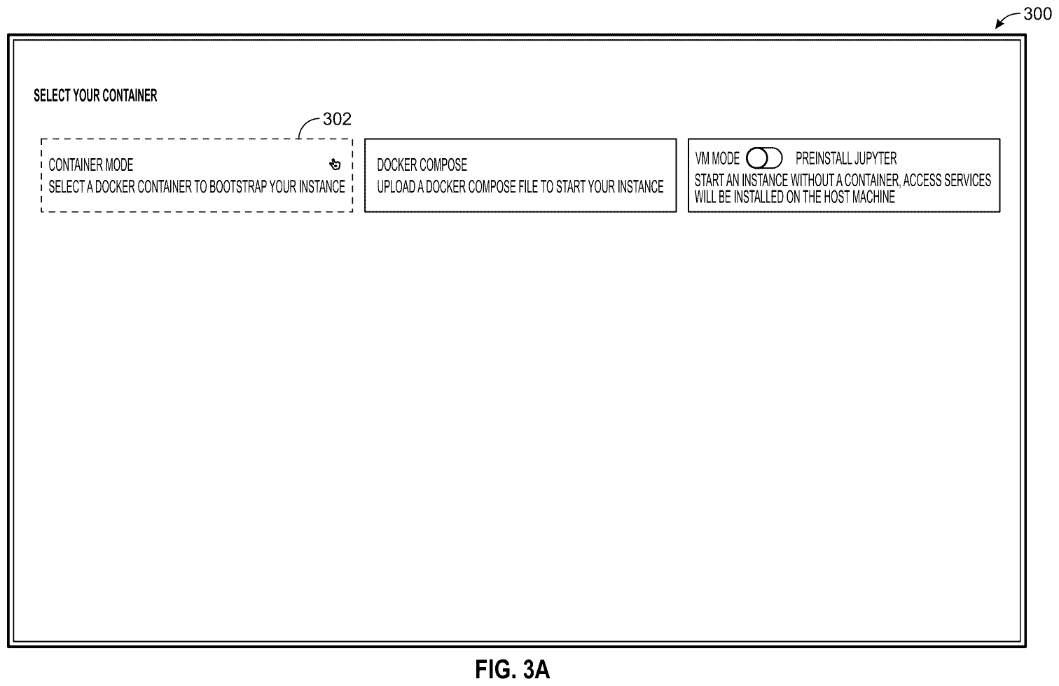

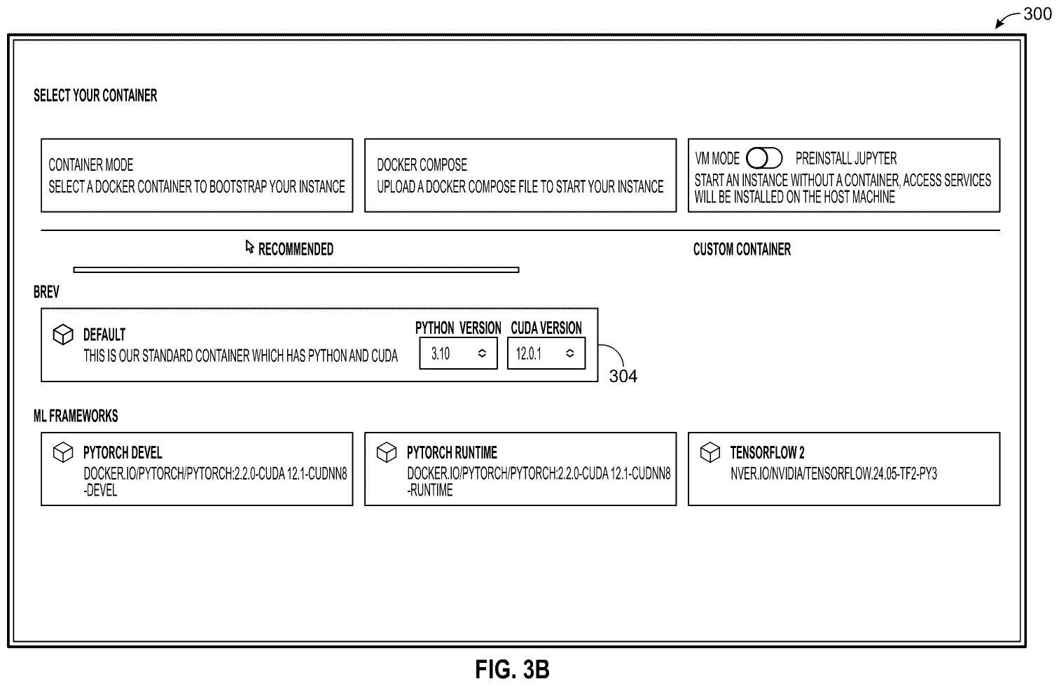

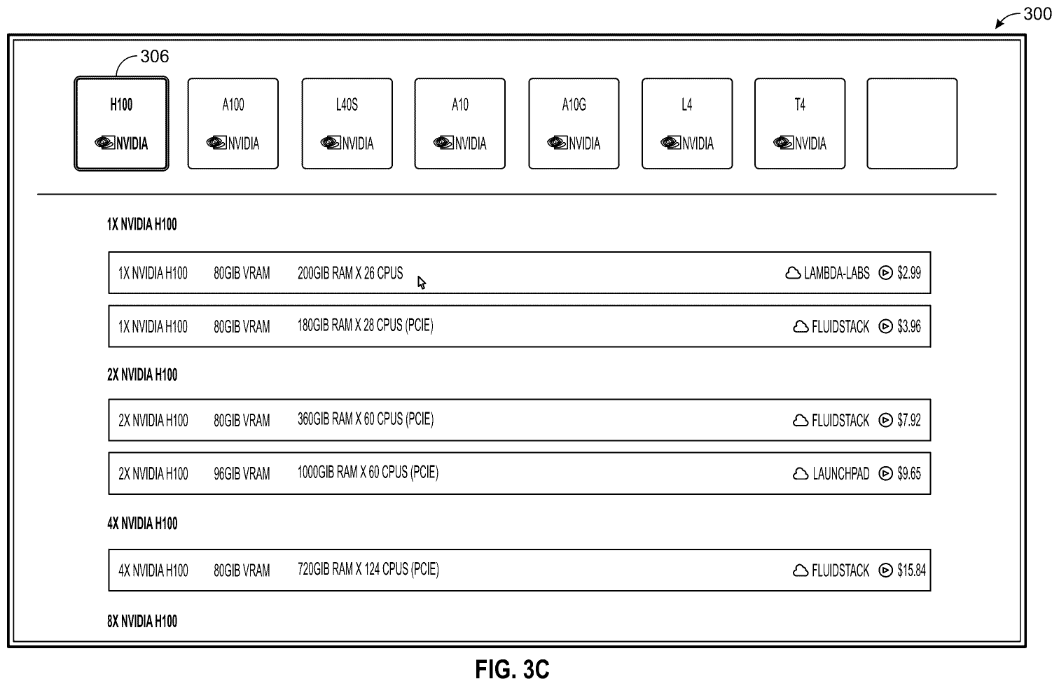

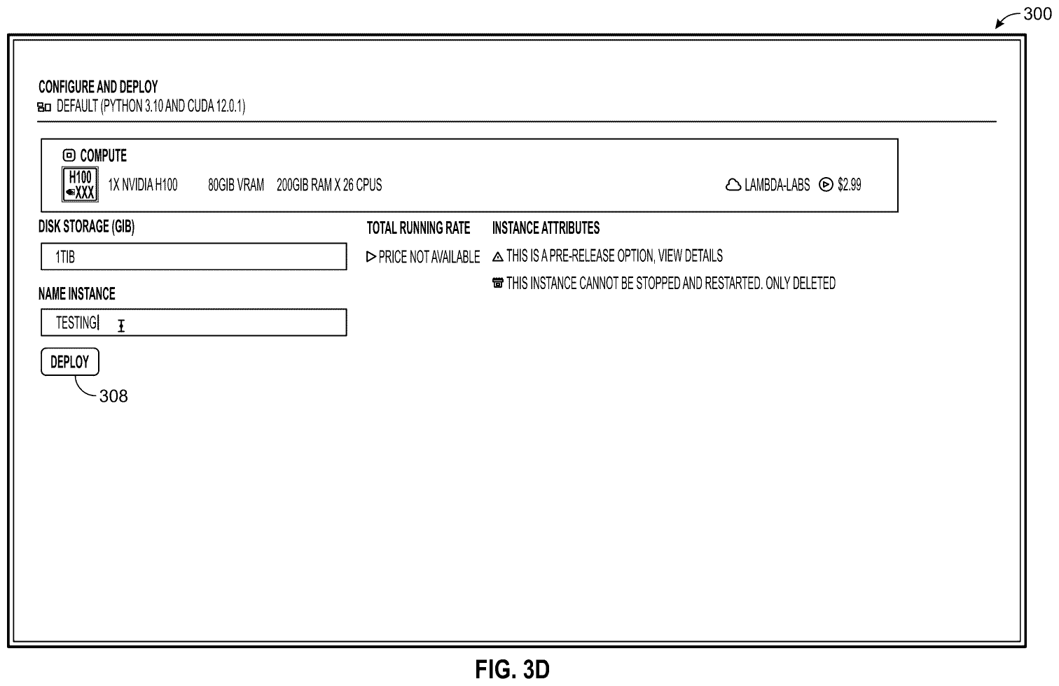

Referring now to FIGS. 3A-3D, depicting an example interface 300 for model customization and deployment in containerized environments, in accordance with some implementations of the present disclosure. The interface 300 can provide options for selecting a deployment configuration, including containerized and virtualized execution modes. In some implementations, the interface system 104 can generate the interface 300 to provide user-selectable deployment options, allowing selection of different containerized environments for inference execution.

Referring to FIG. 3A, the interface 300 can include a selection menu allowing a user to choose and/or otherwise select from multiple deployment modes. The selectable element 302 can correspond to a container mode option, where a user can select a preconfigured container image for deployment. Additionally, interface 300 can include an option for using a container orchestration file (e.g., Docker Compose) and a virtual machine (VM) mode for non-containerized execution environments.

Referring to FIG. 3B, the interface 300 can present a list of recommended container configurations, including pre-built environments with specific machine learning frameworks. The interface 300 can include selectable elements corresponding to machine learning (ML) frameworks, such as PyTorch and TensorFlow. A configuration panel 304 can be provided, allowing the user to modify environment parameters (e.g., Python version, CUDA version, containerized runtime dependencies, execution settings, resource constraints, and/or any framework-specific configurations). The interface system 104 can generate interface 300 to display available containerized environments and corresponding framework versions. Additionally, the ML framework can allow users to specify model compatibility constraints, pre-load optimization libraries, and/or define execution policies for fine-tuning or inference.

Referring to FIG. 3C, the interface 300 can include a hardware selection menu 306, allowing users to allocate computing resources for model execution. The interface system 104 can provide a list of available hardware instances, including different GPU configurations (e.g., NVIDIA H100, A100, L40S). Each instance can display specifications such as VRAM capacity, CPU count, and/or memory allocation. In some implementations, the interface 300 can dynamically update based on availability and pricing information from external resource providers. For example, the interface 300 can retrieve real-time pricing data and adjust selectable instances based on cost efficiency, estimated availability windows, and/or provider-specific constraints.

Referring to FIG. 3D, the interface 300 can include a deployment configuration panel allowing the user to specify additional execution parameters before launching an instance (e.g., customized instance). The user can select a storage allocation, instance attributes (e.g., customizations), and enter an instance name. The total running rate can be calculated based on the selected compute instance, storage allocation, and/or framework dependencies, and the instance attributes can be associated with predefined execution constraints, restart policies, and/or access permissions. A deployment control 308 can be provided, allowing the user to initiate the deployment process. The interface system 104 can receive a deployment request responsive to a user interaction with deployment control 308 and initiate execution based on the selected configuration parameters (e.g., generate a customized instance, generate a software component, package the software component, and/or deploy the software component).

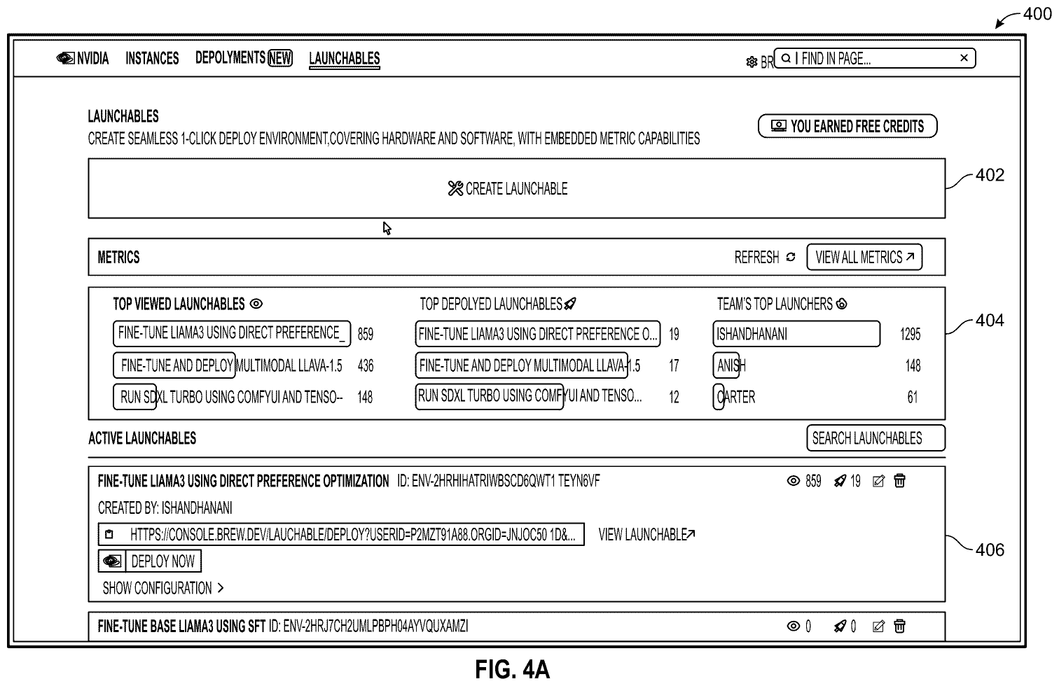

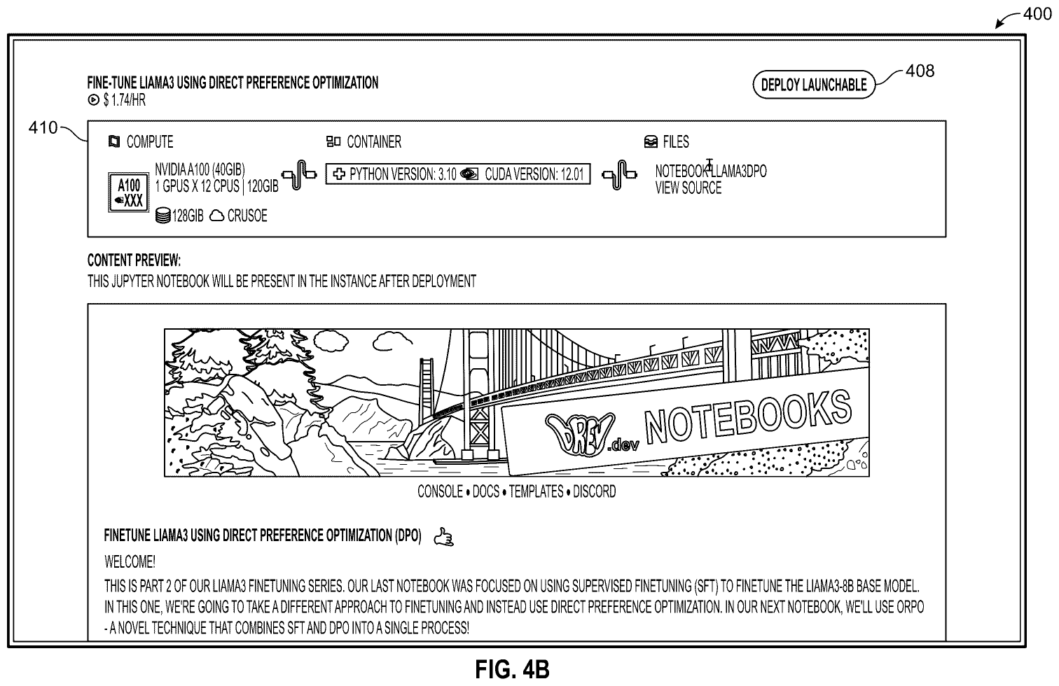

Referring now to FIGS. 4A-4B, depicting an example interface 400 for model customization and deployment in containerized environments, in accordance with some implementations of the present disclosure. FIG. 4A illustrates a launchable instance management interface, where users can create deployable AI model environments using a selectable launchable creation option 402. The interface 400 can further provides metrics tracking for launchable instances, including top-viewed and top-deployed configurations, as well as user-specific deployment activity 404. The active launchables section 406 can list currently available launchable environments with direct deployment options, including unique instance identifiers, creator details, and/or selectable deployment actions. FIG. 4B can illustrate a detailed view of a selected launchable instance, displaying hardware and/or container specifications 410, including compute resources, Python and CUDA versioning and/or any additional framework dependencies, environment variables, execution constraints, and associated Jupyter notebook files and/or any linked data sources, preloaded scripts, and execution logs. The interface 400 can further include a launch action 408 for executing the selected instance with predefined configurations, allowing users to initiate model fine-tuning or inference tasks from the interface 400.

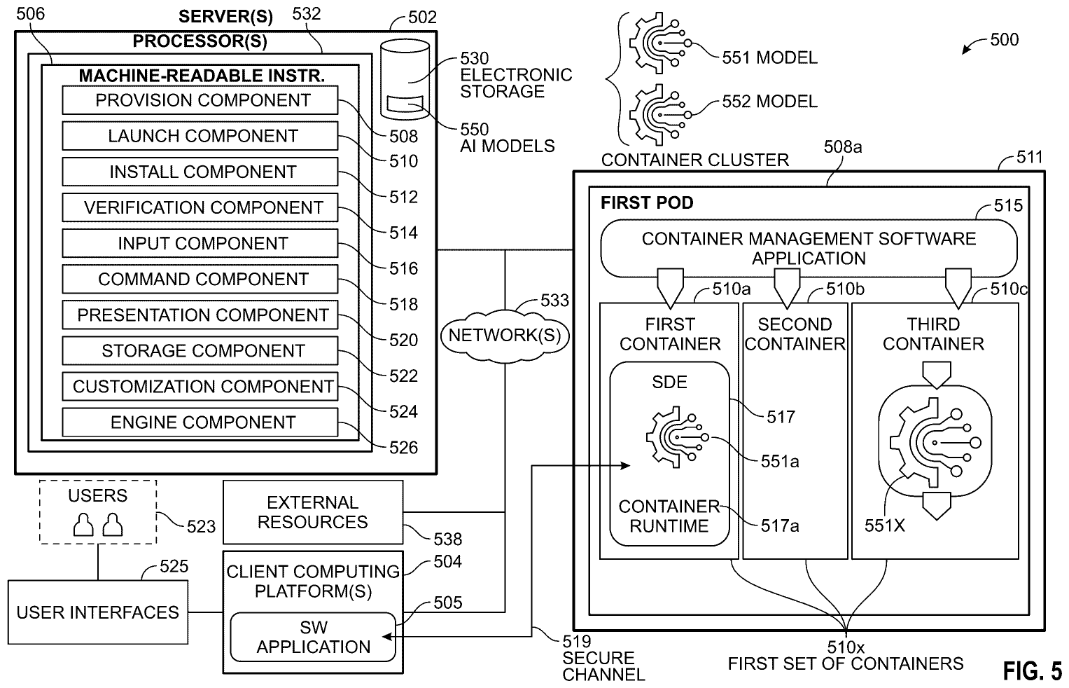

Referring now to FIG. 5, a block diagram of a system 500 configured to support turnkey model customization and deployment of inference engines, in accordance with some implementations of the present disclosure. In some implementations, customization of an artificial intelligence (AI) model can be initiated by an interaction (e.g., one click, multiple interactions with an interface) in a particular user interface, which can launch a container instance in which a particular AI model can be installed. In some implementations, responsive to being launched, individual container instances can be configured to facilitate remote client access to software development environments (SDEs). The system 500 can include the one or more server(s) 502, the client computing platform(s) 504, the user interface(s) 525, (access to) cloud services platforms (not depicted), the external resource(s) 538, and/or other components. In some implementations, the system 500 can include one or more container clusters. The users 523 can include one or more of a first user, a second user, a third user, and/or other users. Remote client access can originate from client computing platform(s) 504, which can be remote from the one or more servers 502.

In some implementations, server(s) 502 can be configured to communicate with one or more client computing platforms 504, container cluster(s) 511, and/or with one or more cloud services platforms according to a client and/or server architecture and/or other architectures. Client computing platform(s) 504 can be configured to communicate with other client computing platforms via server(s) 502 and/or according to a peer-to-peer architecture and/or other architectures. Users can access the system 500 via a client computing platform(s) 504. In some implementations, the server(s) 502 can be configured to communicate with client computing platforms 504, users 523, external resource(s) 538, and/or other entities and/or components, such as through one or more networks 533 (e.g., the Internet).

In some implementations, server(s) 502 can include electronic storage 530, processor(s) 532, machine-readable instructions 506, and/or other components. Server(s) 502 can be configured by machine-readable instructions 506. Machine-readable instructions 506 can include one or more instruction components. Instruction components (for any set of machine-readable instructions) can include computer program components. The instruction components can include one or more of a provision component 508, a launch component 510, an install component 512, a verification component 514, an input component 516, a command component 518, a presentation component 520, a storage component 522, a customization component 524, an engine component 526, and/or other instruction components.

In some implementations, storage component 522 can be configured to manage storage within system 500, including but not limited to electronic storage 530, storage in external resources 538, and storage resources in one or more cloud services platforms. Storage component 522 and/or electronic storage 530 can be configured to store information electronically. Stored information can include artificial intelligence (AI) models 550, such as, by way of non-limiting example, a first AI model 551, a second AI model 552, and so forth. In some implementations, the stored information can include installation information that corresponds to one or more AI models. Individual ones of AI models 550 can include a neural network using over a billion parameters and/or weights. In some implementations, the AI model 551 can correspond to particular installation information, and/or vice versa. For example, certain installation information can correspond to the AI model 552, and/or vice versa. Installation information can include (references to) one or more of (a) software applications, (b) software libraries, (c) software development tools, and/or other information related to software (to be installed). In some implementations, at least some of the installation information can be model-specific (e.g., specific to the AI model 551). An example software application can be a particular version of PYTHON and/or another programming language. For example, an example software library can be a particular version of (NVIDIA's) CUDA and/or another Application Programming Interface (API) for general purpose computing, particularly for GPUs. For example, an example software development tool can include a particular version of a Software Development Kit (SDK), such as, e.g., TENSOR RT from NVIDIA, or another SDK that can run on an inference server, such as, e.g., NVIDIA's Triton Inference Server.

In some implementations, installation information for a particular AI model can be defined and/or configured by a stakeholder (e.g., the owner and/or developer) of the particular AI model. In some implementations, installation information for a particular AI model can be defined and/or configured by a third party. In some implementations, a particular version of an AI model, a software application, a software library can depend on the intended, planned, and/or allowed usage of a user of a particular AI model. For example, training or fine-tuning a particular AI model can include different software (e.g., different versions) than inference. In some implementations, alternatively and/or simultaneously, other requirements (e.g., related to computing resources, computing performance, memory capacity, bandwidth, connection speed, etc.) can depend on the intended, planned, and/or allowed usage of a user of a particular AI model. For example, training and/or fine-tuning a particular AI model can use more available memory than inference. In some implementations, the storage component 522 can be configured to store snapshots, clones, copies, images, and/or preserved states in the storage resources of containers and/or pods, in electronic storage 530, in one or more cloud services platforms, and/or in other storage resources. In some implementations, the storage component 522 can store customized versions of AI models.

In some implementations, the presentation component 520 can be configured to present interfaces (e.g., user interfaces 525) to users (e.g., through client computing platforms 504 associated with the respective users). For example, a user interface can include a user-selectable user interface element that can be associated with a particular AI model. In some implementations, interacting and/or engaging with a particular user-selectable user interface element can facilitated using one click and/or multiple interactions by a particular user. In some implementations, presentation component 520 can be configured to effectuate presentations of interfaces to users 523. In some implementations, presentations by the presentation component 520 can be performed jointly (or at least in some cooperative manner) with one or more components of system 500. In some implementations, presentation component 520 can present offers (e.g., for usage and/or customization of AI models) to particular users. In some implementations, a presentation can indicate a particular AI model is available for use (e.g., customization) in exchange for a particular amount of consideration. In some implementations, selectable user interface elements can be part of a browser extension and/or plug-in. In some implementations, the user interface can be a browser interface. For example, upon installation, a user can use a particular AI model (e.g., for customization) directly from the browser interface.

In some implementations, the provision component 508 can be configured to provision servers and/or other computing hardware. That is, the provision component 508 can provision a server that includes a particular Graphics Processing Unit (GPU), using a particular High-Performance Computing (HPC) architecture, and/or meeting particular requirements, including but not limited to computing resources, computing performance, memory capacity, bandwidth, connection speed, and/or other parameters. Operations by the provision component 508 can be responsive to selections of user-selectable user interface elements. Operations by the provision component 508 can be based on a particular AI model associated with a particular user-selectable user interface element. For example, responsive to selection of a user interface element associated with the AI model 551, the provision component 508 can provision a particular server that includes a particular High-Performance Computing (HPC) architecture that meets the memory capacity requirements of using (e.g., customizing) the AI model 551. In some implementations, the provision component 508 can provision and/or otherwise reserve computing hardware from one or more cloud services platforms (e.g., to launch a container instance on the provisioned server).

In some implementations, the launch component 510 can be configured to launch or spin up one or more containers, including a particular container instance. For example, the launch component 510 can launch a container instance that runs and/or otherwise executes on a server and/or computing system provisioned by the provision component 508. In some implementations, container instances can be launched on a particular cloud services platform. Once a container instance has been launched, a user can have access to the particular GPU and/or HPC architecture within the container instance (e.g., through access to a software development environment). In some implementations, the container instance can be configured to provide a (remotely-accessible server-based) software development environment to a particular user. In some implementations, a user can have root access to the software development environment. In some implementations, launch component 510 can use container a management software application 515. Container management software applications can be configured to create, deploy, and/or share containers. In some implementations, a particular container management software application can manage individual container instances.

In some implementations, the launch component 510 can be configured to launch or spin up pods that include sets of containers. Sets of containers that are placed and/or scheduled together are known as pods. For example, a KUBERNETES node is a pod. Some pods launched by launch component 510 can be referred to as outer pods. In some implementations, these pods can be orchestrated and/or otherwise managed by a container cluster manager (or a container cluster manager platform) such as, e.g., KUBERNETES. The launch component 510 can launch a first pod 508a using a container cluster, e.g., running on a particular cloud services platform. In some implementations, the launch component 510 can launch a second pod (not depicted), a third pod (not depicted), and so forth, using the same container cluster, and/or in some implementations, different container clusters. In some implementations, launched (outer) pods can be configured to execute one or more container management software applications that create, deploy, and/or share containers. In some implementations, container management software applications can provide one or more of dynamic container placement, cluster scheduling, labels and replication controllers, connections within a cluster (e.g., using naming resolution), and/or other services. By way of non-limiting example, a container management software application can be a container platform similar to or based on DOCKER. For example, the first pod 508a can be configured to execute the container management software application 515.

In some implementations, the launch component 510 can be configured to launch or spin up (sets of) container instances. For example, a container instance can be launched in a virtual machine (e.g., a virtual machine that has been spun up using an AMAZON Elastic Compute Cloud (EC2) instance in AWS). In another example, individual ones of these containers can be referred to as inner containers. Launch component 510 can be configured to launch containers using container management software application 515. For example, launch component 510 can launch a first set of containers 510x within first pod 508a. In some implementations, launch component 510 can launch a second set of containers within a second pod (not depicted), a third set of containers within a third pod (not depicted), and so forth. Within the first pod 508a, the launch component 510 can launch a first set of containers 510x, which can include one or more of a first container 510a, a second container 510b, a third container 510c, and so forth. The container management software application 515 can manage individual containers, including the first container 510a.

Launched containers can be configured to provide software development environments (SDEs), in particular remotely-accessible SDEs and/or server-based SDEs. For example, the first container 510a in the first pod 508a can be configured to provide an SDE 517. That is, the SDE 517 can be remotely-accessible from one or more client computing platforms 504. For example, the SDE 517 can be server-based because it uses the server 502 and/or a cloud services platform (and/or resources included therein). By way of non-limiting example, at least some persistent data for SDE 517 can be stored external to any client computing platforms 504.

In some implementations, individual remotely-accessible server-based SDEs can be associated with individual uniform resource locators (URLs). In some implementations, the SDE 517 can include a container runtime 517a. For example, a container runtime can be a runtime in accordance with an Open Container Initiative (OCI) specification. For example, a container runtime can be “runc.” The SDE 517 can support execution of commands and/or (software) applications. A process within SDE 517 can have a current (process) state. For example, a data set within SDE 517 can have a current (data set) state. An application within SDE 517 can have a current (application) state. An SDE can have a current (SDE) state. The first container 510a can have a current (container) state. The container instances 510b and 510c can include a current (container) states. Any of these different types of state can be maintained (e.g., by the server 502 or by a cloud services platform). In some implementations, at least some of the current state can be stored in persistent data storage (e.g., provided by the server 502). For example, a particular current container state (also referred to as container instance state) of the first container 510a can include a deployed (software/web) application. This deployed application can be accessible to one or more users through a particular (public) URL.

In some implementations, the system 500 can receive user input, instructions, and/or other information through the client computing platforms 504 (e.g., from users). The received instructions can include connection instructions, and/or other instructions. A connection instruction can be an instruction to establish a secure (communication) channel. For example, a particular connection instruction can be to establish a secure channel 519 between a particular client computing platform 504 and SDE 517. In some implementations, connection instructions can be transferred using a network communication protocol, which can be a cryptographic network protocol to provide secure communications even over an unsecured network. For example, a particular connection instruction can be (or can be implemented by) a secure shell command (SSH command). For example, the SSH command can be used to create a secure channel such as the secure channel 519. In some implementations, the particular connection instruction can include and/or otherwise use a specific URL that is specific to an SDE such as the SDE 517.

In some implementations, the install component 512 can be configured to download and install AI models, software, and/or other information, e.g., in a particular container instance. For example, the install component 512 can install a local copy 551a of a particular AI model (e.g., of AI model 52) in a particular container instance (e.g., in first container 510a). In some implementations, the install component 512 can be configured to install, in a particular container instance, software in accordance with particular installation information. For example, a (local copy of a) particular AI model can have particular corresponding installation information. By way of non-limiting example, assume a particular container instance has been launched using the launch component 510 such that the user has access to a particular GPU that is suitable for the AI model 551 (e.g., meets the hardware requirements (and/or other requirements) for customization of the particular AI model). In some implementations, the AI model 551 can correspond to particular installation information, including one or more of (a) particular software applications, (b) particular software libraries, and (c) particular software development tools. The install component 512 can install (a) the particular software applications, (b) the particular software libraries, and/or (c) the particular software development tools in the particular container instance, in accordance with the particular installation information, to support customization of the local copy 551a of the AI model 551 through one or more techniques. By way of non-limiting example, the one or more techniques can include (additional) training, fine-tuning, and/or other techniques.

In some implementations, the verification component 514 can be configured to verify whether a particular user has access to a particular GPU (or type of GPU) and/or other component. In some implementations, the verification component 514 can verify whether a particular user has access to a particular server or type of server). In some implementations, the verification component 514 can verify whether a given server and/or GPU has sufficient capabilities for execution of a particular AI model. For example, if suitable hardware is already available to a user, the provision component 508 can perform fewer actions prior to the user executing and/or otherwise using (e.g., customizing) the particular AI model.

In some implementations, the input component 516 can be configured to receive input from users (e.g., through the client computing platforms 504). In some implementations, a local copy of a particular AI model can be customized based on the input from the user. In some implementations, input component 516 can receive particular user input from a particular user through a software application 505 executing locally on a particular client computing platform 504. By way of non-limiting example, the software application 505 can provide a command line interface to the particular user (e.g., a UNIX-based shell). In some implementations, the software application 505 can provide interfaces to users through JUPYTER notebooks. In some implementations, the software application 505 can provide text editing to the particular user, including but not limited to VIM, EMACS, GEDIT, NOTEPADQQ, text editors similar to one of these, notebooks, and/or other text editors. For example, particular user input received by the input component 516 can include one or more instructions to execute a particular command (in a container instance, or in an SDE, e.g., in the SDE 517). In some implementations, particular user input received by the input component 516 can include one or more instructions to execute or launch a particular (software) application (in an SDE, e.g., the SDE 517). In some implementations, these instructions can be transferred through a communication channel (e.g., the secure channel 519) to a container instance or an SDE. In some implementations, these instructions can be provided via a communication channel (e.g., via the secure channel 519).

In some implementations, the command component 518 can be configured to execute commands and/or (software) applications in a particular container, a particular set of containers, a particular pod, and/or a particular container management software application. In some implementations, executions facilitated by the command component 518 can be in accordance with one or more instructions received by the input component 516 and/or another component of the system 500. For example, the command component 518 can execute a command responsive to receiving an instruction for a particular container instance running on a cloud services platform.

In some implementations, the particular execution of a particular (user) command can modify a current application state (e.g., of an application within the SDE 517) into a modified application state. In some implementations, the particular execution of a particular command can modify a current SDE state (e.g., of the SDE 517) into a modified SDE state. In some implementations, the particular execution of a particular command can modify the local copy 551a of the AI model 551 into a modified AI model (e.g., customized instance). In some implementations, the particular execution of a particular command can customize the local copy 551a of the AI model 551 into a customized version of the AI model 551. In some implementations, the particular execution of a particular command can modify a current container instance state into a modified container instance state. In some implementations, the particular execution of a particular software application can modify a current application state (e.g., of an application within the SDE 517) into a modified application state. For example, the modified application state can represent an update to a deployed software application. In some implementations, this update of the deployed software application can be (immediately, e.g., within 1 second, or 50 seconds, or 1 minute) accessible to one or more users through the particular (public) URL for the deployed software application. In some implementations, the modifications provide instantaneous deployment for this software application. In some implementations, the particular execution of a particular software application can modify a current SDE state (e.g., of the SDE 517) into a modified SDE state. In some implementations, the particular execution of a particular software application can modify a current container instance state (e.g., of the first container 510a) into a modified container instance state.

In some implementations, the customization component 524 can be configured to customize AI models into customized versions of the AI models. For example, the customization component 524 can customize the local copy 551a of the AI model 551 into a customized version of the local copy 551a. Customization (using one or more techniques) can be based on user input (e.g., as received through the input component 516). In some implementations, a customization can include additional training of a particular AI model (e.g., based on domain-specific knowledge and/or domain-specific data). In some implementations, customization can include fine-tuning of a particular AI model. In some implementations, fine-tuning can be performed such that at least some of the billions of parameters and/or weights of the local copy 551a of the AI model 551 have been modified. For example, fine-tuning techniques can include one or more of supervised finetuning (SFT), P-tuning, low-rank adaptation (LoRA), and/or other techniques. In some implementations, a customization can include the addition or modification of guardrails. In some implementations, a customization can use reinforcement learning (RL).

In some implementations, the engine component 526 can be configured to generate inference engines for particular AI models. That is, the engine component 526 can generate an inference engine 551x for the customized version of the AI model 551. Inference engines can be targeted to a particular type of hardware and/or a particular cloud services platform (e.g., an H100 on AWS). The engine component 526 can be configured to package inferences engines and their corresponding AI models into containers. For example, the engine component 526 can package the inference engine 551x and the customized version of the AI model 551 into a new container such that (other) users can deploy the inference engine 551x. In some implementations, such new containers can be self-hosted (e.g., using a particular user's AWS account). In some implementations, such new containers can include a (compiled) inference server to invoke operations of a particular AI model, such as, NVIDIA's Triton Inference Server). The launch component 510 can be configured to launch a container instance of this new container. The launch component 510 can deploy inference engine 551x in this container instance (e.g., in third container 510c as depicted in FIG. 5) such that one or more (other) users can run and/or execute inference engine 551x. Upon deployment, the users can run inference on inference engine 551x, using the customized version of AI model 551.

Still referring to FIG. 5, the server(s) 502 can include communication lines, or ports to enable the exchange of information with a network and/or other computing platforms. The server(s) 502 can include a plurality of hardware, software, and/or firmware components operating together to provide the functionality attributed herein to the server(s) 502. For example, the server(s) 502 can be implemented by a group or cloud of computing platforms operating together as the server(s) 502. In some implementations, the server(s) 502, client computing platform(s) 504, and/or external resources 538 can be operatively linked via one or more electronic communication links. For example, such electronic communication links can be established, at least in part, via one or more networks 533 such as the Internet and/or other networks.

In some implementations, a client computing platform 504 can include one or more processors configured to execute computer program components. The computer program components can be configured to allow a user associated with the given client computing platform 504 to interface with the system 500 and/or the external resources 538, and/or provide other functionality attributed herein to the client computing platform(s) 504. For example, the given client computing platform 504 can include one or more of a desktop computer, a laptop computer, a handheld computer, a tablet computing platform, a NetBook, a Smartphone, a gaming console, and/or other computing platforms. In some implementations, a particular client computing platform 504 can be configured to execute software application 505.

In some implementations, the user interfaces 525 can be configured to facilitate interaction between users 523 and the system 500 and/or between users 523 and the client computing platforms 504. For example, the user interfaces 525 can provide an interface through which the users 523 can provide information to and/or receive information from the system 500. In some implementations, the user interface 525 can include one or more of a display screen, touchscreen, monitor, a keyboard, buttons, switches, knobs, levers, mouse, microphones, sensors to capture voice commands, sensors to capture body movement, sensors to capture hand and/or finger gestures, and/or other user interface devices configured to receive and/or convey user input. In some implementations, one or more user interfaces 525 can be included in one or more client computing platforms 504. In some implementations, one or more user interfaces 525 can be included in the system 500.

External resources 538 can include sources of information outside of the system 500, external entities participating with the system 500 (including third parties such as external web-servers), external providers of computation and/or storage services (e.g., a server external to the system 500, or a cloud services platform), external providers of relevant information, and/or other resources. In some implementations, some or all of the functionality attributed herein to the external resources 538 can be provided by resources included in the system 500. In some implementations, one or more external resources 538 can provide information to other components of system 500. In some implementations, the electronic storage 530 can include non-transitory storage media that electronically stores information. The electronic storage media of electronic storage 530 can include one or both of system storage that is provided integrally (e.g., substantially non-removable) with server(s) 502 and/or removable storage that can be removably connectable to the server(s) 502 via, for example, a port (e.g., a USB port, a firewire port, etc.) and/or a drive (e.g., a disk drive, etc.). The electronic storage 530 can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 530 can include one or more virtual storage resources (e.g., cloud storage, a virtual private network, and/or other virtual storage resources). The electronic storage 530 can store software algorithms, information determined by the processor(s) 532, information received from the server(s) 502, information received from the client computing platform(s) 504, and/or other information that allow the system 500 to function as described herein.

In some implementations, the processor(s) 532 can be configured to provide information processing capabilities in the server(s) 502. As such, the processor(s) 532 can include one or more of a digital processor, an analog processor, a digital circuit designed to process information, an analog circuit designed to process information, a state machine, and/or other mechanisms for electronically processing information. Although the processor(s) 532 is shown in FIG. 5 as a single entity, this is for illustrative purposes only. In some implementations, the processor(s) 532 can include a plurality of processing units. These processing units and/or systems can be physically located within the same device, or the processor(s) 532 can represent processing functionality of a plurality of devices operating in coordination. In some implementations, the processor(s) 532 can be configured to execute components 508, 510, 512, 514, 516, 518, 520, 522, 524, and/or 526, and/or other components. The processor(s) 532 can be configured to execute components 508, 510, 512, 514, 516, 518, 520, 522, 524, and/or 526, and/or other components by software; hardware; firmware; some combination of software, hardware, and/or firmware; and/or other mechanisms for configuring processing capabilities on the processor(s) 532. As used herein, the term “component” can refer to any component or set of components that perform the functionality attributed to the component. This can include one or more physical processors during execution of processor readable instructions, the processor readable instructions, circuitry, hardware, storage media, or any other components.

It should be appreciated that although the components 508, 510, 512, 514, 516, 518, 520, 522, 524, and/or 526 are illustrated in FIG. 5 as being implemented within a single processing system and/or unit, in implementations in which the processor(s) 532 includes multiple processing units, one or more of components 508, 510, 512, 514, 516, 518, 520, 522, 524, and/or 526 can be implemented remotely from the other components. The description of the functionality provided by the different components 508, 510, 512, 514, 516, 518, 520, 522, 524, and/or 526 described below is for illustrative purposes only, and is not intended to be limiting, as any of the components 508, 510, 512, 514, 516, 518, 520, 522, 524, and/or 526 can provide more or less functionality than is described. For example, one or more of the components 508, 510, 512, 514, 516, 518, 520, 522, 524, and/or 526 can be eliminated, and some or all of its functionality can be provided by other ones of the components 508, 510, 512, 514, 516, 518, 520, 522, 524, and/or 526. As another example, processor(s) 532 can be configured to execute one or more additional components that can perform some or all of the functionality attributed below to one of the components 508, 510, 512, 514, 516, 518, 520, 522, 524, and/or 526.

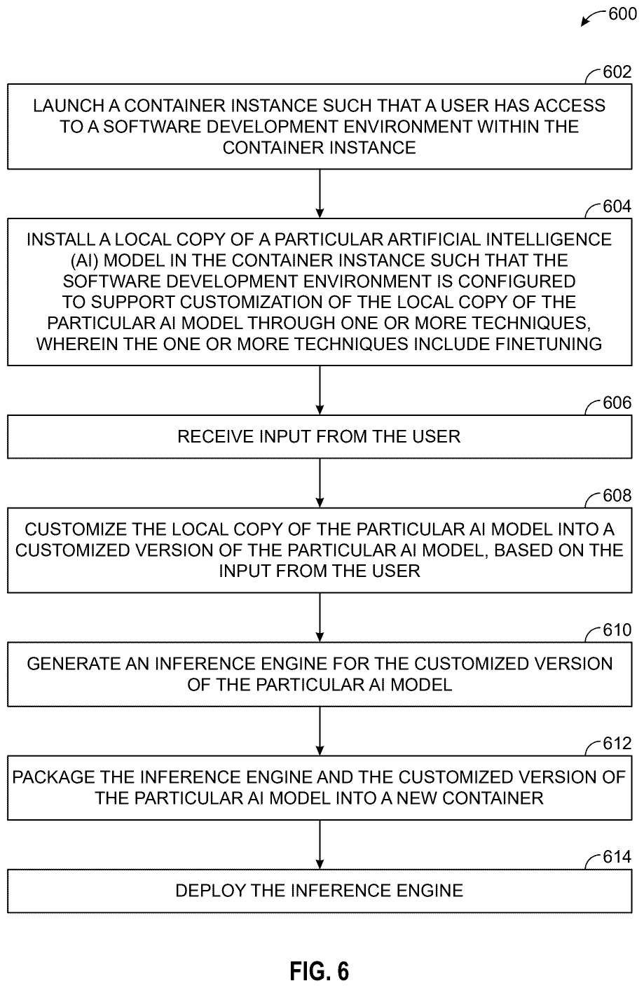

Referring now to FIG. 6, a flow diagram of an example of a method 600 for turnkey model customization and deployment of inference engines, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 8A-8C), one or more computing devices or components thereof (e.g., as described in FIG. 9), and/or one or more data centers or components thereof (e.g., as described in FIG. 10).

In some implementations, method 600 can be implemented in one or more processing devices (e.g., system 100, system 500, a digital processor, an analog processor, a digital circuit designed to process information, an analog circuit designed to process information, a state machine, and/or other mechanisms for electronically processing information). The one or more processing devices can include one or more devices executing some or all of the operations of the method 600 in response to instructions stored electronically on an electronic storage medium. The one or more processing devices can include one or more devices configured through hardware, firmware, and/or software to be implemented for execution of one or more of the operations of the method 600.

At block 602, a container instance can be launched such that a user can have access to a software development environment (SDE) within the container instance. In some implementations, the block 602 can be performed by launching a component having similar features and functionalities as the component 510 of FIG. 5. At block 604, a local copy of a particular artificial intelligence (AI) model can be installed and/or otherwise stored in a container instance such that the SDE can be configured to support customization of the local copy of the particular AI model (e.g., customized instance) through one or more implementations and/or techniques. For example, the one or more implementations can include fine-tuning a base instance of an AI model. In some implementations, the block 604 can be performed by an install component having similar features and functionalities as the install component 512 of FIG. 5. At block 606, the input can be received from the user. In some implementations, the block 606 can be performed by an input component having similar features and functionalities as the input component 516 of FIG. 5.

At block 608, the local copy of the particular AI model can be customized into a customized version of the particular AI model (e.g., base instance), based on, for example, one or more inputs (e.g., customizations) from the user. In some implementations, the block 608 can be performed by a customization component having similar features and functionalities as the customization component 524 of FIG. 5. At block 610, an inference engine (e.g., software component) can be generated for the customized version of the particular AI model. In some implementations, the block 610 can performed by an engine component having similar features and functionalities as the engine component 526 of FIG. 5. At block 612, the inference engine and the customized version of the particular AI model can packaged into a new container (e.g., software component). In some implementations, the block 612 can be performed by an engine component having similar features and functionalities as the engine component 526 of FIG. 5. At block 614, the inference engine (e.g., software component) can be deployed (e.g., within a runtime environment). In some implementations, the block 614 can be performed by a launch component having similar features and functionalities as the launch component 510 of FIG. 5.

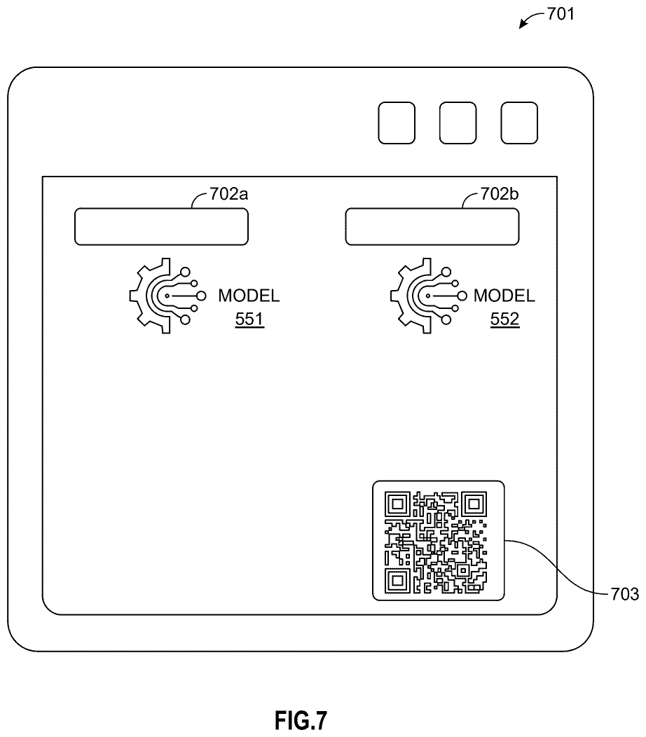

Referring now to FIG. 7, depicting an example interface 701 for model customization and deployment of inference engines, in accordance with some implementations of the present disclosure. For example, FIG. 7 illustrates a user interface 701 and can be implemented and/or otherwise provide during operation of system 100 and/or system 500. In some implementations, user interface 701 can be presented on a local client computing platform 504 as a first presentation of a webpage, mobile application, and/or otherwise interactable interface (e.g., subsequent to a user requesting the webpage and/or interface through, e.g., a browser application executing on the local client computing platform 504). User interface 701 and/or browser interface can include various graphical user interface (GUI) elements (e.g., interactive elements, selectable elements, content, and/or any other interface elements), including an information field 702a, an information field 702b, and/or a code 703 (e.g., QR code and/or any other identifying code or content). Field 702a can be configured to present information to the user. For example, the field 702a can present a message to a user and/or other information. In another example, the field 702a can present, “Click below to customize AI model 551.” In this example, additional information regarding the AI model 551 and/or its usage (e.g., cost and/or consideration associated with using and/or customizing the AI model 52) can be presented. In some implementations, field 702b can be configured to present content and/or other information to the user. For example, the field 702b can present, “Click below to customize AI model 552.” Responsive to the user interacting with one or more fields, the user interface 701 and/or systems 100 and/or 500 can be configured to proceed the user interaction (e.g., launch a container instance, install a local copy of the selected AI model in the container instance, provide the user with access, generate an inference engine for the customized AI model). In some implementations, the code 703 can provide a link that, when presented, provides information, for example, about the AI model 551 and/or the AI model 552.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can be customized and deployed in containerized environments. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures can be implemented in various implementations. For example, different architectures can be implemented that use different techniques for understanding and generating outputs-such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures-such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/SLMs/VLMs/MMLMs/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/SLMs/VLMs/MMLMs/etc.

In various implementations, the LLMs/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources-such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 8A is a block diagram of an example generative language model system 800 suitable for use in implementing at least some implementations of the present disclosure. Generally, the example generative language model system 800 can be implemented in a model customization pipeline. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which can include an LLM, a SLM, a VLM, a multi-modal LM, etc.).

At a high level, the input processor 805 can receive an input 801 including text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 830 (e.g., LLM/SLM/VLM/MMLM/etc.). In some implementations, the input 801 includes plain text in the form of one or more sentences, paragraphs, and/or documents. Additionally, or alternatively, the input 801 can include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 can combine text (or can omit text) with image data, audio data, video data, design data, USD data, and/or other types of input data, such as but not limited to those described herein. Taking raw input text as an example, the input processor 805 can prepare raw input text in various ways. For example, the input processor 805 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 can remove stopwords to reduce noise and focus the generative LM 830 on more meaningful content. The input processor 805 can apply text normalization, for example, by converting all characters to lowercase, removing accents, and/or or handling special cases like contractions or abbreviations to ensure consistency. These are just a few examples, and other types of input processing can be applied.

In some implementations, a RAG component 892 (which can include one or more RAG models, and/or can be performed using the generative LM 830 itself) can be used to retrieve additional information to be used as part of the input 801 or prompt. RAG can be used to enhance the input to the LLM/SLM/VLM/MMLM/etc. with external knowledge, so that answers to specific questions or queries or requests are more relevant-such as in a case where specific knowledge is required. The RAG component 892 can fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 801 can be generated using the query or input to the model (e.g., a question, a request, etc.) in addition to data retrieved using the RAG component 892. In some implementations, the input processor 805 can analyze the input 801 and communicate with the RAG component 892 (or the RAG component 892 can be part of the input processor 805, in implementations) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 can retrieve a prior stored conversation history—or at least a summary thereof—and include the prior conversation history along with the current ask/request as part of the input 801 to the generative LM 830.

The RAG component 892 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 892 and the embeddings of the chunks along with the embeddings of the query can be compared to identify the most similar/related embeddings to the query, which can be supplied to the generative LM 830 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/SLM/VLM/MMLM/etc. Rather than (or in addition to) providing the model with chunks of data extracted from larger sized documents-which can result in a lack of context, factual correctness, language accuracy, etc.—graph RAG can also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/SLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 892 can implement a plugin, API, user interface, and/or other functionality to perform RAG. For example, a graph RAG plug-in can be used by the LLM/SLM/VLM/MMLM/etc. to run queries against the knowledge graph to extract relevant information for feeding to the model, and a standard or vector RAG plug-in can be used to run queries against a vector database. For example, the graph database can interact with a REST interface plug-in such that the graph database is decoupled from the vector database and/or the embeddings models.

The tokenizer 810 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy can depend on factors such as the language being processed, the task at hand, and/or characteristics of the training dataset. As such, the tokenizer 810 can convert the (e.g., processed) text into a structured format according to tokenization schema being implemented in the particular implementation.

The embedding component 820 can use any known embedding technique to transform discrete tokens into (e.g., dense, continuous vector) representations of semantic meaning. For example, the embedding component 820 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 805 can resize the data to a standard size compatible with format of a corresponding input channel and/or can normalize pixel values to a common range (e.g., 0 to 1) to ensure a consistent representation, and the embedding component 820 can encode the image data using any known technique (e.g., using one or more convolutional neural networks (CNNs) to extract visual features). In some implementations in which the input 801 includes audio data, the input processor 805 can resample an audio file to a consistent sampling rate for uniform processing, and the embedding component 820 can use any known technique to extract and encode audio features-such as in the form of a spectrogram (e.g., a mel-spectrogram). In some implementations in which the input 801 includes video data, the input processor 805 can extract frames or apply resizing to extracted frames, and the embedding component 820 can extract features such as optical flow embeddings or video embeddings and/or can encode temporal information or sequences of frames. In some implementations in which the input 801 includes multi-modal data, the embedding component 820 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 can apply an encoded representation of the input 801 to the generative LM 830, and the generative LM 830 can process the encoded representation of the input 801 to generate an output 890, which can include responsive text and/or other types of data.

As described herein, in some implementations, the generative LM 830 can be configured to access or use—or capable of accessing or using—plug-ins/APIs 895 (which can include one or more plug-ins, application programming interfaces (APIs), databases, data stores, repositories, etc.). For example, for certain tasks or operations that the generative LM 830 is not ideally suited for, the model can have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 895 to the plug-in/API 895, the plug-in/API 895 can process the information and return an answer to the generative LM 830, and the generative LM 830 can use the response to generate the output 890. This process can be repeated—e.g., recursively—for any number of iterations and using any number of plug-ins/APIs 895 until an output 890 that addresses each ask/question/request/process/operation/etc. from the input 801 can be generated. As such, the model(s) can not only rely on its own knowledge from training on a large dataset(s) and/or from data retrieved using the RAG component 892, but also on the expertise or optimized nature of one or more external resources-such as the plug-ins/APIs 895.

FIG. 8B is a block diagram of an example implementation in which the generative LM 830 includes a transformer encoder-decoder. Generally, the generative LM 830 can be customized and deployed in containerized environments. For example, assume input text such as “Who discovered gravity” is tokenized (e.g., by the tokenizer 810 of FIG. 8A) into tokens such as words, and each token is encoded (e.g., by the embedding component 820 of FIG. 8A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 840 can convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 can generate a first token, and the generation mechanism 855 can apply the generated token as an input during a second pass. The process can repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the SoftMax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 can output some decoded (e.g., vector) representation of the input being applied during a particular pass. The classifier 850 can include a multi-class classifier including one or more neural network layers that project the decoded (e.g., vector) representation into a corresponding dimensionality (e.g., one dimension for each supported word or token in the output vocabulary) and a SoftMax operation that converts logits to probabilities. As such, the generation mechanism 855 can select or sample a word or token based on a corresponding predicted probability (e.g., select the word with the highest predicted probability) and append it to the output from a previous pass, generating each word or token sequentially. The generation mechanism 855 can repeat the process, triggering successive decoder inputs and corresponding predictions until selecting or sampling a symbol or token that represents the end of the response, at which point, the generation mechanism 855 can output the generated response.

FIG. 8C is a block diagram of an example implementation in which the generative LM 830 includes a decoder-only transformer architecture. For example, the decoder(s) 860 of FIG. 8C can operate similarly as the decoder(s) 845 of FIG. 8B except each of the decoder(s) 860 of FIG. 8C omits the encoder-decoder self-attention layer (since there is no encoder in this implementation). As such, the decoder(s) 860 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 860. As with the decoder(s) 845 of FIG. 8B, each token (e.g., word) can flow through a separate path in the decoder(s) 860, and the decoder(s) 860, a classifier 865, and a generation mechanism 870 can use auto-regression to sequentially generate one token at a time until predicting a symbol or token that represents the end of the response. The classifier 865 and the generation mechanism 870 can operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. Generally, the generative LM 830 can be customized and deployed in containerized environments. These and other architectures described herein are meant simply as examples, and other suitable architectures can be implemented within the scope of the present disclosure.

### Example Computing Device

FIG. 9 is a block diagram of an example computing device(s) 900 suitable for use in implementing some implementations of the present disclosure. Generally, the example computing device(s) 900 can facilitate and generate customized instances of AI models, generate software components, perform packaging and/or deploying. Computing device 900 can include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one implementation, the computing device(s) 900 can include one or more virtual machines (VMs), and/or any of the components thereof can include virtual components (e.g., virtual hardware components). For non-limiting examples, one or more of the GPUs 908 can include one or more vGPUs, one or more of the CPUs 906 can include one or more vCPUs, and/or one or more of the logic units 920 can include one or more virtual logic units. As such, a computing device(s) 900 can include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some implementations, a presentation component 918, such as a display device, can be considered an I/O component 914 (e.g., if the display is a touch screen). As another example, the CPUs 906 and/or GPUs 908 can include memory (e.g., the memory 904 can be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 can represent one or more links or busses, such as an address bus, a data bus, a control bus, or a combination thereof. The interconnect system 902 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 906 can be directly connected to the memory 904. Further, the CPU 906 can be directly connected to the GPU 908. Where there is direct, or point-to-point connection between components, the interconnect system 902 can include a PCIe link to carry out the connection. In these examples, a PCI bus need not be included in the computing device 900.

The memory 904 can include any of a variety of computer-readable media. The computer-readable media can be any available media that can be accessed by the computing device 900. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 904 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device 900. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 906 can be configured to execute at least some of the computer-readable instructions to control one or more components of the computing device 900 to perform one or more of the methods and/or processes described herein. The CPU(s) 906 can each include one or more cores (e.g., one, two, four, eight, twenty-eight, seventy-two, etc.) that are capable of handling a multitude of software threads simultaneously. The CPU(s) 906 can include any type of processor, and can include different types of processors depending on the type of computing device 900 implemented (e.g., processors with fewer cores for mobile devices and processors with more cores for servers). For example, depending on the type of computing device 900, the processor can be an Advanced RISC Machines (ARM) processor implemented using Reduced Instruction Set Computing (RISC) or an x86 processor implemented using Complex Instruction Set Computing (CISC). The computing device 900 can include one or more CPUs 906 in addition to one or more microprocessors or supplementary co-processors, such as math co-processors.

In addition to or alternatively from the CPU(s) 906, the GPU(s) 908 can be configured to execute at least some of the computer-readable instructions to control one or more components of the computing device 900 to perform one or more of the methods and/or processes described herein. One or more of the GPU(s) 908 can be an integrated GPU (e.g., with one or more of the CPU(s) 906 and/or one or more of the GPU(s) 908 can be a discrete GPU. In implementations, one or more of the GPU(s) 908 can be a coprocessor of one or more of the CPU(s) 906. The GPU(s) 908 can be used by the computing device 900 to render graphics (e.g., 3D graphics) or perform general purpose computations. For example, the GPU(s) 908 can be used for General-Purpose computing on GPUs (GPGPU). The GPU(s) 908 can include hundreds or thousands of cores that are capable of handling hundreds or thousands of software threads simultaneously. The GPU(s) 908 can generate pixel data for output images in response to rendering commands (e.g., rendering commands from the CPU(s) 906 received via a host interface). The GPU(s) 908 can include graphics memory, such as display memory, for storing pixel data or any other suitable data, such as GPGPU data. The display memory can be included as part of the memory 904. The GPU(s) 908 can include two or more GPUs operating in parallel (e.g., via a link). The link can directly connect the GPUs (e.g., using NVLINK) or can connect the GPUs through a switch (e.g., using NVSwitch). When combined together, each GPU 908 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 906 and/or the GPU(s) 908, the logic unit(s) 920 can be configured to execute at least some of the computer-readable instructions to control one or more components of the computing device 900 to perform one or more of the methods and/or processes described herein. In implementations, the CPU(s) 906, the GPU(s) 908, and/or the logic unit(s) 920 can discretely or jointly perform any combination of the methods, processes and/or portions thereof. One or more of the logic units 920 can be part of and/or integrated in one or more of the CPU(s) 906 and/or the GPU(s) 908 and/or one or more of the logic units 920 can be discrete components or otherwise external to the CPU(s) 906 and/or the GPU(s) 908. In implementations, one or more of the logic units 920 can be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 can include one or more receivers, transmitters, and/or transceivers that allow the computing device 900 to communicate with other computing devices via an electronic communication network, included wired and/or wireless communications. The communication interface 910 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 920 and/or communication interface 910 can include one or more data processing units (DPUs) to transmit data received over a network and/or through interconnect system 902 directly to (e.g., a memory of) one or more GPU(s) 908.

The I/O ports 912 can allow the computing device 900 to be logically coupled to other devices including the I/O components 914, the presentation component(s) 918, and/or other components, some of which can be built in to (e.g., integrated in) the computing device 900. Illustrative I/O components 914 include a microphone, mouse, keyboard, joystick, game pad, game controller, satellite dish, scanner, printer, wireless device, etc. The I/O components 914 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 can include depth cameras, such as stereoscopic camera systems, infrared camera systems, RGB camera systems, touchscreen technology, and combinations of these, for gesture detection and recognition. Additionally, the computing device 900 can include accelerometers or gyroscopes (e.g., as part of an inertia measurement unit (IMU)) that allow detection of motion. In some examples, the output of the accelerometers or gyroscopes can be used by the computing device 900 to render immersive augmented reality or virtual reality.

The power supply 916 can include a hard-wired power supply, a battery power supply, or a combination thereof. The power supply 916 can provide power to the computing device 900 to allow the components of the computing device 900 to operate.

The presentation component(s) 918 can include a display (e.g., a monitor, a touch screen, a television screen, a heads-up-display (HUD), other display types, or a combination thereof), speakers, and/or other presentation components. The presentation component(s) 918 can receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that can be used in at least one implementations of the present disclosure. Generally, the example data center 1000 can store and/or otherwise maintain customized and base instances of AI models, software components, and/or software images and instances. The data center 1000 can include a data center infrastructure layer 1010, a framework layer 1020, a software layer 1030, and/or an application layer 1040.

As shown in FIG. 10, the data center infrastructure layer 1010 can include a resource orchestrator 1012, grouped computing resources 1014, and node computing resources (“node C.R.s”) 1016(1)-1016(N), where “N” represents any whole, positive integer. In at least one implementation, node C.R.s 1016(1)-1016(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1016(1)-1016(N) can correspond to a server having one or more of the above-mentioned computing resources. In addition, in some implementations, the node C.R.s 1016(1)-10161(N) can include one or more virtual components, such as vGPUs, vCPUs, and/or the like, and/or one or more of the node C.R.s 1016(1)-1016(N) can correspond to a virtual machine (VM).

In at least one implementation, grouped computing resources 1014 can include separate groupings of node C.R.s 1016 housed within one or more racks (not shown), or many racks housed in data centers at various geographical locations (also not shown). Separate groupings of node C.R.s 1016 within grouped computing resources 1014 can include grouped compute, network, memory or storage resources that can be configured or allocated to support one or more workloads. In at least one implementation, several node C.R.s 1016 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 1012 can configure or otherwise control one or more node C.R.s 1016(1)-1016(N) and/or grouped computing resources 1014. In at least one implementation, resource orchestrator 1012 can include a software design infrastructure (SDI) management entity for the data center 1000. The resource orchestrator 1012 can include hardware, software, or some combination thereof.

In at least one implementation, as shown in FIG. 10, framework layer 1020 can include a job scheduler 1028, a configuration manager 1034, a resource manager 1036, and/or a distributed file system 1038. The framework layer 1020 can include a framework to support software 1032 of software layer 1030 and/or one or more application(s) 1042 of application layer 1040. The software 1032 or application(s) 1042 can respectively include web-based service software or applications, such as those provided by Amazon Web Services, Google Cloud and Microsoft Azure. The framework layer 1020 can be, but is not limited to, a type of free and open-source software web application framework such as Apache Spark™ (hereinafter “Spark”) that can use distributed file system 1038 for large-scale data processing (e.g., “big data”). In at least one implementation, job scheduler 1028 can include a Spark driver to facilitate scheduling of workloads supported by various layers of data center 1000. The configuration manager 1034 can be capable of configuring different layers such as software layer 1030 and framework layer 1020 including Spark and distributed file system 1038 for supporting large-scale data processing. The resource manager 1036 can be capable of managing clustered or grouped computing resources mapped to or allocated for support of distributed file system 1038 and job scheduler 1028. In at least one implementation, clustered or grouped computing resources can include grouped computing resource 1014 at data center infrastructure layer 1010. The resource manager 1036 can coordinate with resource orchestrator 1012 to manage these mapped or allocated computing resources.

In at least one implementation, software 1032 included in software layer 1030 can include software used by at least portions of node C.R.s 1016(1)-1016(N), grouped computing resources 1014, and/or distributed file system 1038 of framework layer 1020. One or more types of software can include, but are not limited to, Internet web page search software, e-mail virus scan software, database software, and streaming video content software.

In at least one implementation, application(s) 1042 included in application layer 1040 can include one or more types of applications used by at least portions of node C.R.s 1016(1)-1016(N), grouped computing resources 1014, and/or distributed file system 1038 of framework layer 1020. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 1034, resource manager 1036, and resource orchestrator 1012 can implement any number and type of self-modifying actions based on any amount and type of data acquired in any technically feasible fashion. Self-modifying actions can relieve a data center operator of data center 1000 from making possibly bad configuration decisions and possibly avoiding underutilized and/or poor performing portions of a data center.

The data center 1000 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 1000. In at least one implementation, trained or deployed machine learning models corresponding to one or more neural networks can be used to infer or predict information using resources described above with respect to the data center 1000 by using weight parameters calculated through one or more training techniques, such as but not limited to those described herein.

In at least one implementation, the data center 1000 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 900 of FIG. 9—e.g., each device can include similar components, features, and/or functionality of the computing device(s) 900. In addition, where backend devices (e.g., servers, NAS, etc.) are implemented, the backend devices can be included as part of a data center 1000, an example of which is described in more detail herein with respect to FIG. 10.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 900 described herein with respect to FIG. 9. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors configured to:
receive at least one customization of at least one artificial intelligence (AI) model corresponding to a base instance;
generate a customized instance of the at least one AI model by updating the base instance of the at least one AI model based on the at least one customization;
generate a software component configured to perform at least one operation using the customized instance of the at least one AI model;
package the software component and the customized instance of the at least one AI model into a first container instance; and
deploy the software component within a runtime environment.

2. The system of claim 1, wherein updating the base instance comprises performing at least one of (i) fine-tuning, (ii) applying prompt tuning, or (iii) updating at least one model parameter of the base instance.

3. The system of claim 1, wherein the first container instance comprises the runtime environment configured to execute the software component using the customized instance of the at least one AI model.

4. The system of claim 1, wherein the first container instance corresponds to an instantiation of a container image, and wherein the container image executes in an execution environment configured to provision at least one computing resource for executing the first container instance.

5. The system of claim 4, wherein packaging the software component and the customized instance comprises:
generating the container image comprising the software component, the customized instance of the at least one AI model, and the runtime environment configured to execute the software component; and
instantiating the first container instance by loading the container image into the execution environment and allocating the at least one computing resource for execution.

6. The system of claim 1, wherein the one or more processors are configured to:
launch a second container instance comprising a software development environment (SDE); and
install the at least one AI model in the second container instance, wherein the second container instance receives the at least one customization prior to generating the customized instance of the at least one AI model.

7. The system of claim 6, wherein the one or more processors are configured to:
provide, via the SDE, a user interface comprising a plurality of selectable elements, wherein at least one first selectable element of the plurality of selectable elements corresponds to configuring and deploying a plurality of software components, and wherein at least one second selectable element of the plurality of selectable elements corresponds to updating at least one model parameter; and
receive, via the SDE from the at least one first selectable element, a request to configure and deploy the software component, wherein receiving the at least one customization comprises receiving, from the at least one second selectable element, the at least one model parameter to update the base instance of the at least one AI model.

8. The system of claim 7, wherein the user interface comprises at least one content item corresponding to deployment and configuration information of the software component, the deployment and configuration information comprises at least one of (i) compute information, (ii) container information, or (iii) file information.

9. The system of claim 7, wherein deploying the software component within the runtime environment is responsive to receiving a selection of at least one of the plurality of selectable elements.

10. The system of claim 1, wherein generating the software component comprises:
generating software logic configured to receive at least one input and apply the at least one input to the customized instance of the at least one AI model to cause the customized instance to generate at least one output.

11. The system of claim 1, wherein the one or more processors are to execute operations comprising:
a system for customizing one or more AI models;
a system for deploying one or more inference engines;
a system for packaging the one or more inference engines and the one or more AI models into one or more containers;
a system for executing one or more software components invoking the one or more AI models;
a system for implementing one or more containerized execution environments;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system, comprising:
one or more processors configured to:
receive at least one customization of at least one artificial intelligence (AI) model corresponding to a base instance;
generate a customized instance of the at least one AI model by updating the base instance of the at least one AI model based on the at least one customization;
generate a software component configured to perform at least one operation using the customized instance of the at least one AI model;
package the software component and the customized instance of the at least one AI model into a container image; and
provide, to a deployment system, the container image configured for execution of the software component in a container instance.

13. The system of claim 12, wherein updating the base instance comprises performing at least one of (i) fine-tuning, (ii) applying prompt tuning, or (iii) updating at least one model parameter of the base instance.

14. The system of claim 12, wherein the container instance comprises a runtime environment configured to execute the software component using the customized instance of the at least one AI model.

15. The system of claim 12, wherein the container image executes in an execution environment configured to provision at least one computing resource for executing the container instance.

16. The system of claim 12, wherein the one or more processors are configured to:
provide, via a software development environment (SDE), a user interface comprising a plurality of selectable elements, wherein at least one first selectable element of the plurality of selectable elements corresponds to configuring and deploying a plurality of software components, and wherein at least one second selectable element of the plurality of selectable elements corresponds to updating at least one model parameter; and
receive, via the SDE from the at least one first selectable element, a request to configure and deploy the software component, wherein receiving the at least one customization comprises receiving, from the at least one second selectable element, the at least one model parameter to update the base instance of the at least one AI model.

17. The system of claim 16, wherein the user interface comprises at least one content item corresponding to deployment and configuration information of the software component, the deployment and configuration information comprises at least one of (i) compute information, (ii) container information, or (iii) file information.

18. The system of claim 17, wherein deploying the software component within a runtime environment is responsive to receiving a selection of at least one of the plurality of selectable elements.

19. The system of claim 12, wherein generating the software component comprises:
generating software logic configured to receive at least one input and apply the at least one input to the customized instance of the at least one AI model to cause the customized instance to generate at least one output.

20. A method, comprising:
receiving, using one or more processors, at least one customization of at least one artificial intelligence (AI) model corresponding to a base instance;
generating, using the one or more processors, a customized instance of the at least one AI model by updating the base instance of the at least one AI model based on the at least one customization;
generating, using the one or more processors, a software component configured to perform at least one operation using the customized instance of the at least one AI model;
packaging, using the one or more processors, the software component and the customized instance of the at least one AI model into a first container instance; and
deploying, using the one or more processors, the software component within a runtime environment.
